(19) United States
(12) Patent Application Publication
(10) Pub. No.: US 2023/0317935 A1
(43) Pub. Date: Oct. 5, 2023

(54) SILICON COMPOSITE ANODE MATERIALS FOR Li-ION BATTERIES

(71) Applicant: THE REGENTS OF THE UNIVERSITY OF CALIFORNIA, Oakland, CA (US)

(72) Inventors: Zheng CHEN, San Diego, CA (US); Ying ZHANG, Gongqingcheng City (CN)

(73) Assignee: THE REGENTS OF THE UNIVERSITY OF CALIFORNIA, Oakland, CA (US)

(21) Appl. No.: 18/022,971

(22) PCT Filed: Aug. 25, 2021
(86) PCT No.: PCT/US2021/047615

§ 371 Date: Feb. 23, 2023

Related U.S. Application Data
(60) Provisional application No. 63/070,065, filed on Aug. 25, 2020.

(51) Int. Cl. H01M 4/38; H01M 4/36; H01M 4/04

(52) U.S. Cl. CPC H01M 4/386; H01M 4/362; H01M 4/0471; H01M 2004/027

(57) ABSTRACT

A composition for use as an anode material for a Li-ion battery is generated by magnesiothermic reduction of a SiO₂ constituent in a silicon-containing precursor, where silicon in the precursor is reduced to form a Si/SiO₂ composite network with crystalline Si domains embedded within an amorphous SiO₂ matrix. In some embodiments, the precursor may be diatomite or montmorillonite.

### RELATED APPLICATIONS

This application claims the benefit of the priority of U.S. Provisional Application No. 63/070,065, filed Aug. 25, 2020, which is incorporated herein by reference in its entirety.

### FIELD OF THE INVENTION

The present invention relates to materials and methods for a new generation of Si composite anode material and related next-generation lithium-ion batteries.

### BACKGROUND

High capacity electrode materials remain in high demand for the development of next generation of lithium-ion batteries (LIBs) with significantly improved energy density compared with current state-of-the-art technology. Silicon (Si), with nearly 10 times theoretical capacity (3580 mAh g⁻¹) of the dominant graphite anode material (372 mAh g⁻¹) used in today's commercial LIBs, has attracted considerable interest in the last decade. However, Si-based anodes suffer extreme volume change (˜380%) upon lithiation and delithiation, resulting in break-down of solid electrolyte interphases (SEIs), electrode pulverization, and rapid capacity fading during repeated charge/discharge process.

A variety of Si nanostructures such as nanoparticles (<150 nm), nanotubes, graphene cage@Si, nanoporous Si-C composites, pomegranate C@Si and 2D-structure sandwiched Si have demonstrated improved cycling stability in the lab-scale test. The effectiveness of these designs was mainly attributed to their smaller feature sizes and/or higher porosity, which provided more free space for strain release. As a result, low tap density (<0.5 g cm⁻³) is a common feature for these materials. For industrial implementation, however, high tap density electrodes are often required. In addition, these tailored Si nanostructures pose concerns in the cost for large scale application due to their relatively complicated synthesis processes. While micron-sized Si has gained increased interest in industry, making them stable remains a huge challenge because of their poor tolerance to mechanical strain from lithiation and delithiation process. Some advanced binders have been developed to enhance electrode-level integrity, including self-healing polymer, pulley-polyrotaxane, cross-linked binder and supremely elastic gel polymer. While such strategy showed great promise in improving cycling stability, the cost concern associated with the Si materials and the complicated synthesis of these novel binders should be addressed before scalable application. Combing micron-sized particles with nanoporous structures is an effective approach to simultaneously provide buffer space for volume expansion and high tap density. For example, the recent work on ant-nest-like microscale porous C@Si anode showed long-cycling stability with high specific capacity and high tap density (0.84 g cm⁻³), demonstrating the advantage of such structure. Its synthesis relies on alloying Si and magnesium (Mg) at high temperature and thermal nitridation of the Mg—Si alloy in nitrogen (N₂) followed by acid leaching to remove the Mg₃N₂ by-product, and then coated with polydopamine followed by high temperature annealing. Similar to many other Si nanostructures, the relatively complicated synthesis is likely an obstacle for practical applications.

Thin sheet or layer structure can effectively shorten the diffusion pathway of lithium-ions, and improve the electrochemical performances of 2D Si anode. For example, Zhang et al. reporting in. Nat. Commun. 10, 849 (2019) prepared a sandwich structure of Si nanoparticles wrapped by MXene nanosheets (a class 2D material Ti₃C₂Tₓ originated from the Ti₃AlC₂ precursor), the Si/MXene composite delivered the reversible capacity of ˜1200 mAh g⁻¹ and corresponding retention of 65% over 280 cycles. Despite the impressive benefits in 2D Si anodes, there remains a huge obstacle to realize the scale-up implementation due to their relatively complicated synthesis process and high cost of such Si nanomaterials. By contrast, the micron Si with large tap density (>0.5 g cm⁻³) has gained widespread attention in industry recently, and the main challenge is how to maintain its mechanical stability during repeated charge/discharge process. With respect to practical applications, low cost, resource abundancy, and scalability are critical requirements for Si-based materials.

### BRIEF SUMMARY

According to embodiments described herein, a sustainable and scalable method is disclosed to synthesize hierarchically porous micron-sized Si particles from the low-cost a precursor, which serves as both the precursor and the template. In a first embodiment, through a one-step magnesiothermic reduction, the SiO₂ constituent in diatomite is reduced to form a Si/SiO₂ composite network with 10-30 nm crystalline Si domains embedded within an amorphous SiO₂ matrix. In a second embodiment, magnesiothermic reduction is used to convert the main component of SiO₂ in montmorillonite into a nanoscale crystalline-amorphous network consisting of Si and SiO₂. Controlling the reduction time leads to an optimal ratio between the crystalline Si and the amorphous SiO₂ constituent, which endows the composite structure with high capacity and excellent cycling stability. For example, 90% capacity can be retained after 500 cycles at 0.2 C for sample reduced by 6 h without any coating or prelithiation. The full cell with such Si/SiO₂ as the anode and LiNi_{0.8}Co_{0.1}Mn_{0.1}O₂ as the cathode showed ˜80% capacity retention after 200 cycles. This work creates a unique path towards sustainable and scalable production of high-performance micron-sized Si anodes, offering new opportunities for potential industrial applications.

Diatomite, a class of diatom-derived mineral with identified global reserves of more than 2 billion tons, carries microscale morphology and intrinsic hierarchical pore structure (from nano- to microscale). As silica (SiO₂) is the dominant constituent in their solid framework, they can be an ideal precursor to synthesize Si anodes. Inspired by such a nature-based structure, a simple and scalable method is provided to synthesize hierarchically porous micron-sized Si particles from the low-cost diatomite precursor.

Montmorillonite, showing a general formula of Al₂[Si₄O₁₀](OH)₂ or 4SiO₂·Al₂O₃·H₂O, is a class of silicate mineral with proved global reserve of more than 10 billion tons, carries monolithic morphology and intrinsic layer structures, with T-O-T alternating layers (“T” represents tetrahedral [SiO₄]⁴⁻ and “O” represents octahedral [AlO₂(OH)₄]⁵⁻). Such a nature-designed structure can serve as an ideal precursor for making monolithic Si anode due to its functional composition and structure: i) its dominant SiO₂ constituent can be readily reduced to Si at overall high yield; ii) the alternating T and O layers provide intrinsic barrier to form large Si crystal domains during high temperature reaction due to the high thermal stability of Al₂O₃; iii) the Al₂O₃ nanolayer (˜Å) also serve as a porogen after removal which leads to the formation of nanoporous structure, and iv) it is abundant, low cost and biodegradable.

The inventive Si/SiO₂ composite material is made of two basic components: crystalline Si domains and an amorphous SiO₂ matrix, where Si provides Li-storage capacity and SiO₂ offers local structure stability. The Si/SiO₂ composite can be easily synthesized by the one-step magnesiothermic reduction from SiO₂ precursor (e.g., diatomite). According to different application requirements, the ratio of Si/SiO₂ can be controlled by the reduction time, where longer times yield increased Si content). For example, the application fields requiring high capacity can be achieved via long reduction time and resulting more Si content. For the lithium-ion batteries, an optimal ratio between the crystalline Si and the amorphous SiO₂ can be obtained at moderate reduction time, which endows both high capacity and cycling stability.

When such a Si/SiO₂ material is used as the anode of a battery, its performances are investigated via repeated charge/discharge cycles. During the charge process, the Si domains can adsorb Li ions and provide capacity (lithiation stage); while these Si domains suffer extreme volume expansion of ˜380%. The SiO₂ matrix cannot adsorb Li ions, so it can maintain local structure stability without any volume expansion. In this case, the total volume expansion of Si/SiO₂ composite can be reduced, leading to a good stability during long-term cycling. By applying this material into the battery, it can make high cycling stability for Si anode intrinsically.

The novel features and advantages of the inventive approach include that Si anode materials compose Si and SiO₂ to form a composite structure. The Si and SiO₂ are both in the nanoscale to provide high capacity and high stability. The ratio between the crystalline Si and the amorphous SiO₂ can be controlled by reduction time (the longer the time, the more the Si constituent). The cylinder surface exhibits an intrinsic hierarchical porous structure from nano to microscale, which is more exquisite than other traditional Si materials. The tap density is 0.9-1.1 g cm⁻³, which is at least two times greater than other nanostructured Si materials (e.g., <0.5 g cm⁻³). The cost of diatomite is only 10-1000 $/ton, which is much lower than other commercial Si precursors (e.g., silane). A one-step magnesiothermic reduction process can be used, which is much shorter than other production approaches for commercial Si (e.g., multi-step chemical vapor deposition method). The resulting batteries have high cycling stability, with the capacity retention reaching 90% after 500 cycles—far superior to other Si anodes.

In one aspect of the invention, a composition for use as an anode material for a Li-ion battery is generated by magnesiothermic reduction of a SiO₂ constituent in silicon-containing precursor, wherein silicon in the precursor is reduced to form a Si/SiO₂ composite network with crystalline Si domains embedded within an amorphous SiO₂ matrix. In some embodiments, the precursor can be diatomite. In other embodiments, the precursor can be montmorillonite. The magnesiothermic reduction is preferably carried out for a reduction time selected to control a ratio between the crystalline Si domains and the amorphous SiO₂ constituent. The reduction time may be within a range of 2 to 10 hours. The magnesiothermic reduction is carried out in an inert atmosphere. The resulting the crystalline Si domains may have a size distribution in a range of 10-30 nm.

In another aspect of the invention, a composition for use as an anode for a lithium-ion battery comprises a Si-precursor-derived hierarchical porous Si/SiO₂ network which may be formed by magnesiothermic reduction of the Si-precursor. In some embodiments, the precursor can be diatomite. In other embodiments, the precursor can be montmorillonite. The magnesiothermic reduction may be carried out for a reduction time selected to control a ratio between crystalline Si domains and an amorphous SiO₂ constituent. The reduction time is typically within a range of 2 to 10 hours and is carried out in an inert atmosphere. The resulting crystalline Si domains have a size distribution in a range of 10-30 nm.

In still another aspect of the invention, an anode for a Li-ion battery is formed from a Si/SiO₂ composite network with crystalline Si domains embedded within an amorphous SiO₂ matrix, where the Si/SiO₂ composite network is generated by magnesiothermic reduction of a SiO₂ constituent in a precursor. In some embodiments, the precursor can be diatomite. In other embodiments, the precursor can be montmorillonite. The magnesiothermic reduction is carried out for a reduction time selected to control a ratio between the crystalline Si domains and the amorphous SiO₂ constituent. The reduction time is typically within a range of 2 to 10 hours and is carried out in an inert atmosphere. The resulting the crystalline Si domains may have a size distribution in a range of 10-30 nm.

In yet another aspect, the invention includes a method for fabricating an anode for a Li-ion battery by reducing a Si-containing precursor to form a Si/SiO₂ composite network with crystalline Si domains embedded within an amorphous SiO₂ matrix.

Reducing Si-containing precursor includes the steps of mixing the precursor with magnesium to form a powder; heating the powder in an inert atmosphere for a reduction time; removing magnesium by-product by acid leaching; and washing and drying the acid-leached material to form the Si/SiO₂ composite network. In some embodiments, the precursor can be diatomite. In other embodiments, the precursor can be montmorillonite. The reduction time is typically within a range of 2 to 10 hours. The resulting the crystalline Si domains may have a size distribution in a range of 10-30 nm.

### BRIEF DESCRIPTION OF THE DRAWINGS

FIG. 1A is a schematic illustration of diatomite SiO₂, diatomite-derived Si/SiO₂ and lithiated Si; FIGS. 1B-1D are SEM images of diatomite SiO₂, diatomite-derived Si/SiO₂ composites, and lithiated Si/SiO₂, respectively; FIGS. 1E-1G are digital photographs of diatomite SiO₂, diatomite-derived Si/SiO₂ composites, and lithiated Si/SiO₂, respectively.

FIGS. 2A-2G are plots showing the structure and composition characterization of diatomite, D-Si and C-Si samples, where FIG. 2A shows XRD patterns of diatomite, crude D-Si product after 6 h of reduction, D-Si samples at different reduction time and the C-Si sample (for reference); FIG. 2B plots N₂ adsorption-desorption isotherms of diatomite, different diatomite-derived Si samples (D-Si) and commercial Si (C-Si); FIG. 2C plots BET surface area of diatomite, different D-Si samples and C-Si, FIG. 2D plots pore size distributions of samples based on the density functional theory (DFT) using the “cylinder pore model”; FIG. 2E shows Raman spectra of diatomite and different D-Si samples; FIG. 2F shows XPS full-spectra of diatomite and different D-Si samples; and FIG. 2G plots Si2p XPS fine spectra of diatomite and different D-Si samples using 284.6 eV of Cls as the calibration reference.

FIGS. 3A-3F are SEM images of diatomite (FIGS. 3A-3C) and D-Si-6 (FIGS. 3D-3F), respectively. Insets in FIGS. 3A and 3D show particle size distribution of diatomite and D-Si-6, respectively. Insets in FIGS. 3C and 3F show zoomed-in images of a large macropore on the wall of diatomite and D-Si-6, respectively.

FIG. 4A is a TEM image of D-Si-6; FIG. 4B is a HR-TEM image of D-Si-6 with Si nanocrystalline domains highlighted in dashed ovals; FIG. 4C is a HR-TEM image with clear lattice fringes and SAED pattern (inset) of D-Si-6; FIG. 4D is an elemental mapping of D-Si-6 with uniform distribution of Si and O elements; FIGS. 4E-4F provide EELS analysis of D-Si-6 with atomic composition of Si and O elements; FIG. 4G shows EELS patterns of D-Si-6 sample with abundancy of Si⁰ (Si elementary substance) and Si⁴⁺ (SiO₂) via TEM testing.

FIG. 5A plots the cycling stability of different Si samples at 0.2 C (the cycling was performed at 0.1 C for the first 3 activation cycles and 0.2 C for the following cycles; 1 C=3.5 A g⁻¹ of Si anode); FIG. 5B plots CV curves of D-Si-6 anode at 0.2 mV s⁻¹ for the first 10 cycles; FIG. 5C shows long-term cycling stability of D-Si-6 anode with a mass loading of 0.6 mg cm⁻² at 0.2-1 C; FIG. 5D plots representative charge/discharge curves of D-Si-6 anode in 500 cycles at 0.2 C; and FIG. 5E plots areal capacity of D-Si-6 anode under different mass loadings at 0.1 C. Inset shows the dependence of electrode areal capacity (first cycle delithiation capacity) on the Si mass loading.

FIGS. 6A-6C are SEM images of D-Si-6 sample after 5 charge/discharge cycles at 0.1 C, where the inset of FIG. 6A shows particle size distribution of lithiated D-Si-6, and the inset of FIG. 6C shows zoom-in image of a large macropore of lithiated D-Si-6; FIGS. 6D-6G are TEM images of D-Si-6 sample after 1^{st} lithiation at 0.1 C (6D), after 1^{st} delithiation at 0.1 C (6E), after 5^{th} lithiation at 0.1 C (6F), and after 100^{th} lithiation at 0.1 C (6G).

FIGS. 7A-7B are plots of cycling stability of D-Si-6 anodes under different mass loadings from 0.3 to 3 mg cm⁻² at the charge/discharge rate of 0.1 C for 100 cycles, where FIG. 7A shows delithiation specific capacity of D-Si-6 anode under different mass loadings, and FIG. 7B plots areal capacity of D-Si-6 anode under different mass loadings.

FIG. 8 is a comparison of volumetric capacity between the inventive diatomite-derived Si and the best Si anodes reported in the literature.

FIGS. 9A-9H provide comparisons of full cell application using D-Si-6 as the anode and either LiFePO₄ (LFP) (FIGS. 9A-9D) or LiNi_{0.8}Co_{0.1}Mn_{0.1}O₂ (NCM811) (FIGS. 9E-9H), where FIGS. 9A and 9E are XRD patterns and FIGS. 9B and 9F are SEM images of the respective cathodes; FIGS. 9C and 9G are charge/discharge curves, cycle stability, cycling performances, and FIGS. 9D and 9H plot Coulombic efficiency of the respective electrodes for 200 cycles.

FIGS. 10A-10D compare cycle performances of LFP/D-Si-6 and LFP/C-Si full cells, respectively, where FIGS. 10A and 10C show representative charge/discharge curves and FIGS. 10B and 10D show cycle stability and Coulombic efficiency after 100 cycles.

FIGS. 11A-11B plot electrochemical performances for LFP/D-Si-6 full cell, where FIG. 11A shows CV curves within 2.5-4.0 V at 0.2 mV s⁻¹ before and after cycling for 100 cycles; and FIG. 11B shows Nyquist plots of EIS curves before and after cycling for 100 cycles.

FIGS. 12A-12C are plots of cycle performances of NCM811/D-Si-6 full cell (11.5 mg cm⁻² of NCM811 cathode and 2.5 mg cm⁻² of D-Si-6 anode) at 0.1 C rate, where FIG. 12A plots the first charge curves of NCM811 cathode and D-Si-6 anode, respectively; FIG. 12B shows representative charge/discharge curves of the full cell during 200 cycles (specific capacity was calculated based on the total mass of 14.0 mg cm⁻² including both the cathode and the anode); and FIG. 12C plots cycle stability and Coulombic efficiency of the full cell during the 200 cycles.

FIGS. 13A-13C compare the synthesis/manufacturing pathways for different types of Si anode structures, where FIG. 13A shows synthesis of hierarchical Si nanoparticle (SiNP) assemblies, which relies on preformed Si NP made from silane; FIG. 13B shows synthesis of Si hierarchical structures from dealloying process, and FIG. 13C shows one-step synthesis of diatomite-derived Si hierarchical structure from diatomite SiO₂.

FIGS. 14A-14B are schematic illustrations of montmorillonite SiO₂ and montmorillonite-derived Si/SiO₂, respectively; FIGS. 14C-14D show the micro structure of montmorillonite and montmorillonite-derived Si, respectively; FIG. 14E provides a comparison of tap density for montmorillonite, montmorillonite-derived Si, and nano silicon.

FIGS. 15A-15E plot structure and composition characterization of 20 montmorillonite and M-Si samples where FIG. 15A shows XRD patterns of montmorillonite and M-Si samples at different reduction time; FIG. 15B is a plot of N₂ adsorption-desorption isotherms of montmorillonite and different M-Si samples; FIG. 15C provides pore size distribution of montmorillonite and different M-Si samples; FIG. 15D shows Si2p XPS fine spectra of montmorillonite and different M-Si samples using 284.6 eV of C1s as the calibration reference; and FIG. 15E graphs atomic contents of Si⁰ (Si) and Si⁴⁺ (SiO₂) in different M-Si samples.

FIG. 16 provides SEM and TEM images of the material samples where panels (a)-(c) show montmorillonite and panels (d)-(f) show M-Si-4; panel (g) is a TEM image of M-Si-4; panel; (h) is a HR-TEM image of M-Si-4 with Si nanocrystalline domains and SiO₂ matrix; and panel (i) is a HR-TEM image with clear lattice fringes and SAED pattern (inset) of M-Si-4.

FIG. 17A plots the cycling stability of different M-Si samples at 0.2 C (the cycling was performed at 0.1 C for the first 3 activation cycles and 0.2 C for the following cycles; 1C=3.5 A g⁻¹ of Si anode); FIG. 17B shows rate performances of different M-Si samples at 0.1-2 C; FIG. 17C provides CV curves of M-Si-4 anode at 0.2 mV s⁻¹ for the first 3 cycles and cyclic cycle; FIG. 17D plots long-term cycling stability of M-Si-4 anode with a mass loading of 1 mg cm⁻² at 0.2 and 0.5 C; FIG. 17E plots representative charge/discharge curves of M-Si-4 anode in 500 cycles at 0.2 C; FIG. 17F plots areal capacity of M-Si-4 anode under different mass loadings at 0.1 C; FIGS. 17G-17H are cross-section images of M-Si-4 electrode (3 mg cm⁻²) before and after cycling, respectively.

FIGS. 18A-18C provide cycle performances of NCM811/M-Si-4 pouch cell (14.5 mg cm⁻² of NCM811 cathode and 3.0 mg cm⁻² of M-Si-4 anode) at 0.1 C, where FIG. 18A shows the first charge curves of NCM811 cathode and M-Si-4 anode; FIG. 18B plots representative charge/discharge curves of the full cell during 200 cycles (specific capacity based on the total mass of 17.5 mg cm⁻² of the cathode plus anode); and FIG. 18C compares cycle stability and Coulombic efficiency of the full cell during 200 cycles.

### DETAILED DESCRIPTION OF EMBODIMENTS

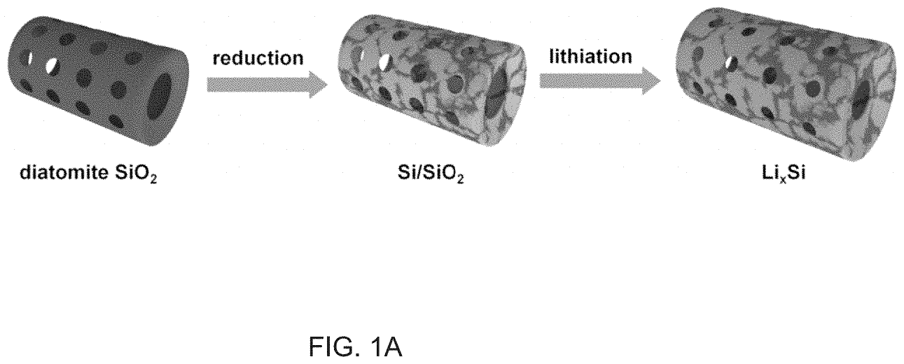

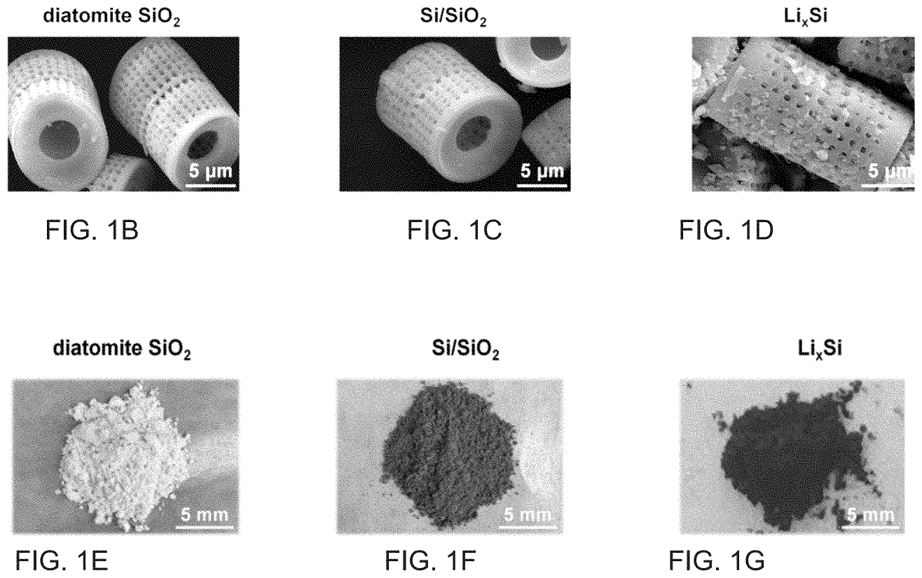

A controlled one-step magnesiothermic reduction process was used to partially reduce the SiO₂ constituent, leading to the formation of a Si/SiO₂ composite network with 10-30 nm crystalline Si domains embedded within an amorphous SiO₂ matrix (FIG. 1A), where the darker regions on the Si/SiO₂ and LiₓSi images represent the SiO₂ constituent. FIGS. 1B-1D provide SEM images of diatomite SiO₂, diatomite-derived Si/SiO₂ composites, and lithiated Si/SiO₂, respectively. FIGS. 1E-1G are digital photographs of diatomite SiO₂, diatomite-derived Si/SiO₂ composites, and lithiated Si/SiO₂, respectively. The crystalline Si domains provide Li-storage capacity while the SiO₂ matrix offers local structure stability. The hierarchical pore structure further provides high framework stability. Controlling the reduction time can lead to an optimal ratio between the crystalline Si and the amorphous SiO₂ constituent, which endows the composite structure with high capacity and excellent cycling stability. Unlike previous approaches that heavily relied on specially tailored precursors, this work creates a unique path towards sustainable and scalable production of high-performance micron-sized Si anodes, offering new opportunities for potential industrial applications.

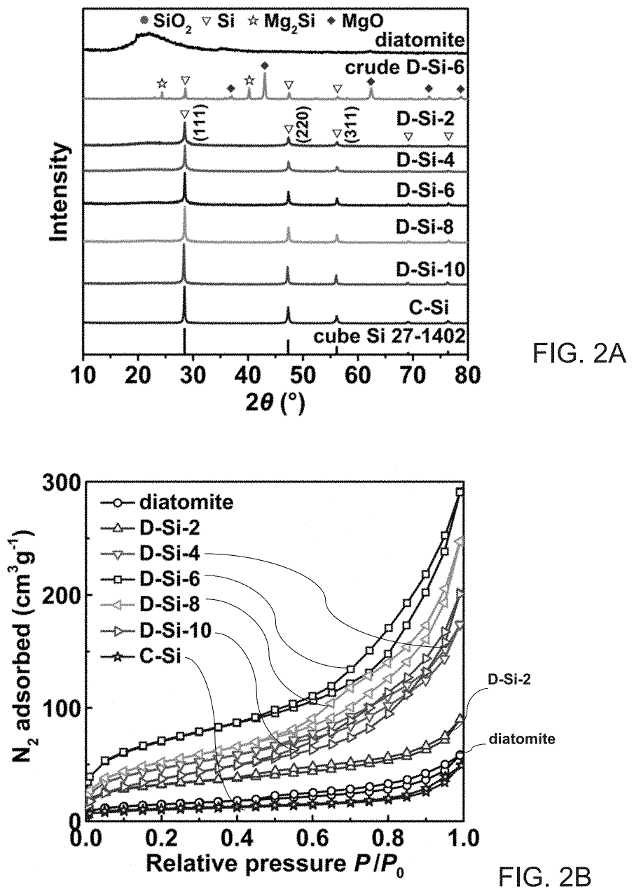

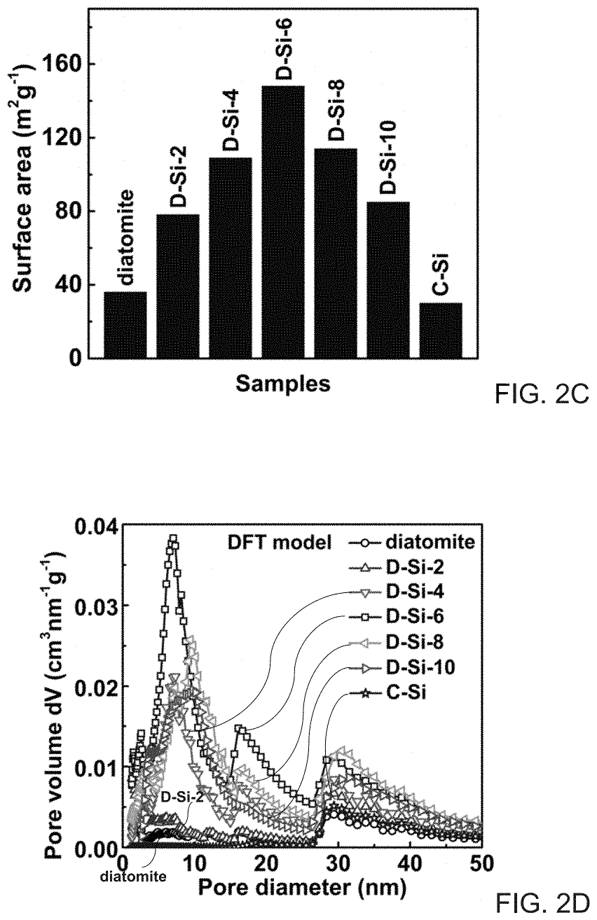

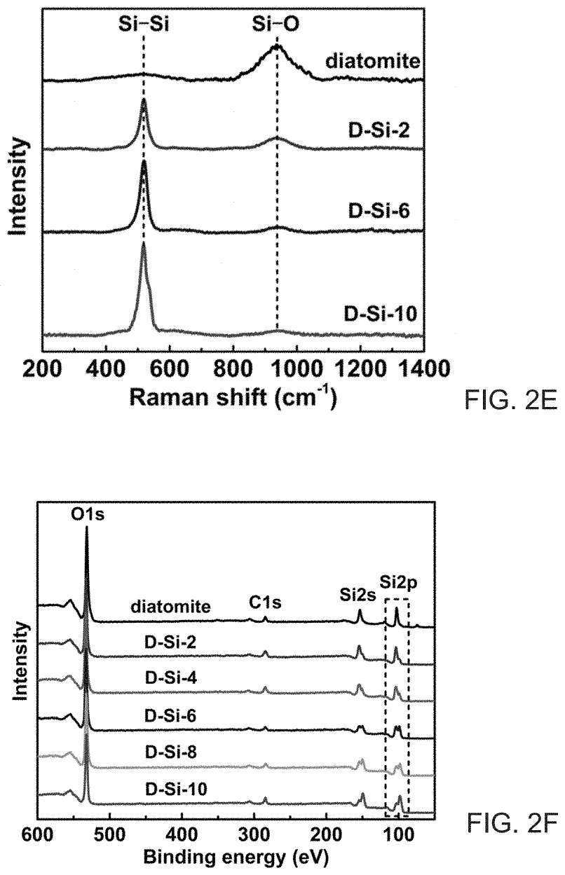

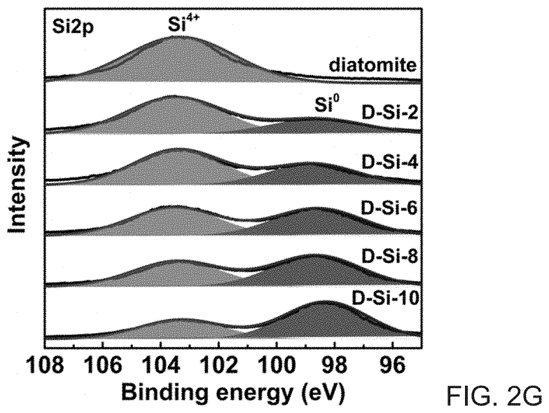

FIG. 2A shows the X-ray diffraction (XRD) patterns of the original diatomite, crude D-Si (diatomite-derived Si) product after reduction, purified D-Si obtained after washing and the C-Si (a commercial Si powder with cubic crystal structure and average particles size of 800 nm). A broad peak at 22° in the XRD pattern of the diatomite suggests the presence of amorphous SiO₂. After magnesiothermic reduction, the crude product consists of a mixture of Mg₂Si, MgO, and Si. Due to the removal of the by-products (Mg₂Si, MgO) after acid washing, all of the D-Si samples exhibited characteristic peaks at 2θ=28°, 47°, 56°, 69°, and 76°, corresponding to the (111), (220), (311), (400), and (331) planes of cubic Si (JCPDF No. 27-1402). With reaction time prolonged from 2 to 10 h, the intensities of their diffraction peaks increased, indicating continuous development of crystallinity of the Si domains. Table 1 lists the corresponding average grain size of D-Si samples grew from 26 to 39 nm, as calculated using Scherrer equation.

TABLE 1

| | D | S_{BET} | Vₜ | dₐ | Si⁰ | Yield | Tap density |
|---|---|---|---|---|---|---|---|
| Samples | (nm) | (m² g⁻¹) | (cm³ g⁻¹) | (nm) | (at %) | (wt %) | (g cm⁻³) |
| diatomite | — | 36 | 0.108 | 12.0 | 0 | — | — |
| D-Si-2 | 26 | 78 | 0.172 | 8.8 | 35 | 80 | 1.02 |
| D-Si-4 | 29 | 109 | 0.338 | 12.4 | 43 | 75 | 0.98 |
| D-Si-6 | 33 | 148 | 0.583 | 15.8 | 52 | 70 | 0.90 |
| D-Si-8 | 35 | 114 | 0.489 | 17.2 | 62 | 64 | 0.93 |
| D-Si-10 | 39 | 85 | 0.392 | 18.4 | 73 | 58 | 0.95 |
| C-Si | 34 | 30 | 0.094 | 12.5 | 90 | — | 0.20 |

The N₂ adsorption-desorption isotherms of the diatomite, D-Si and C-Si were measured to investigate the porous structure (FIG. 2B). The diatomite sample exhibited a small N₂ uptake, implying its low Brunauer-Emmett-Teller (BET) surface area (S_{BET}=36 m² g⁻¹). All of the five D-Si samples displayed type IV isotherms with a hysteresis loop indicating the existence of considerable mesopores of ˜10 and ˜30 nm, attributing to the hierarchical pore structure. As the reduction time increases, the S_{BET} of the D-Si samples increased from 78 (D-Si-2) to 148 m² g⁻¹ (D-Si-6), which is probably due to the removal of the organic moieties followed by the creation of mesopores during the thermal reduction. Further increasing the reduction time led to a decrease of the S_{BET} with D-Si-10 having S_{BET} of only 85 m² g⁻¹ (FIG. 2C). This is likely caused by the increase of crystalline Si domain size and pore collapsing/widening during the prolonged reduction and heating, as reflected by the increase of average pore size (dₐ) from 8.8 (D-Si-2) to 18.4 nm (D-Si-10) (Table 1). All the D-Si samples showed small pores at ˜10 nm and large pores at ˜30 nm (FIG. 2D), indicating a hierarchical pore structure in the mesopore range. The change of the total pore volume (Vt) of the D-Si samples followed the same trend as their surface area, with the D-Si-6 sample showing the highest value of 0.583 cm³ g⁻¹ (Table 1).

Raman spectra of the diatomite and the representative D-Si samples further confirm the composition evolution during the reduction process. The broad peak at around 940 cm⁻¹ can be assigned to the Si—O bond of SiO₂, and the sharp peak located at around 520 cm⁻¹ is associated with the Si—Si bond. As shown in FIG. 2E, the intensity of the Si—O peak decreased rapidly while the Si—Si peak increased significantly during the entire period of thermal reduction.

More quantitative results on the composition changes were obtained by X-ray photoelectron spectroscopy (XPS). The XPS spectra of the diatomite and all the D-Si samples showed apparent peaks of O, Si and C element (FIG. 2F). Specifically, apparent peaks at approximately 533.0, 284.6, 154.0, and 103.0 eV were ascribed to O1s, C1s, Si₂s, and Si2p characteristic, respectively. As expected, the diatomite showed one significant Si2p peak at around 103 eV, which can be assigned to Si⁴⁺ in SiO₂. For all the D-Si samples, a new peak at ˜98.6 eV can be observed, which was attributed to the formation of Si⁰. The relative atomic ratio of Si⁰ (Si⁰/Si⁴⁺+Si⁰) was measured to be 35, 43, 52, 62 and 73 at % for D-Si-2, D-Si-4, D-Si-6, D-Si-8, and D-Si-10, respectively (FIG. 2G). This is expected as longer reduction time led to the formation of more Si⁰.

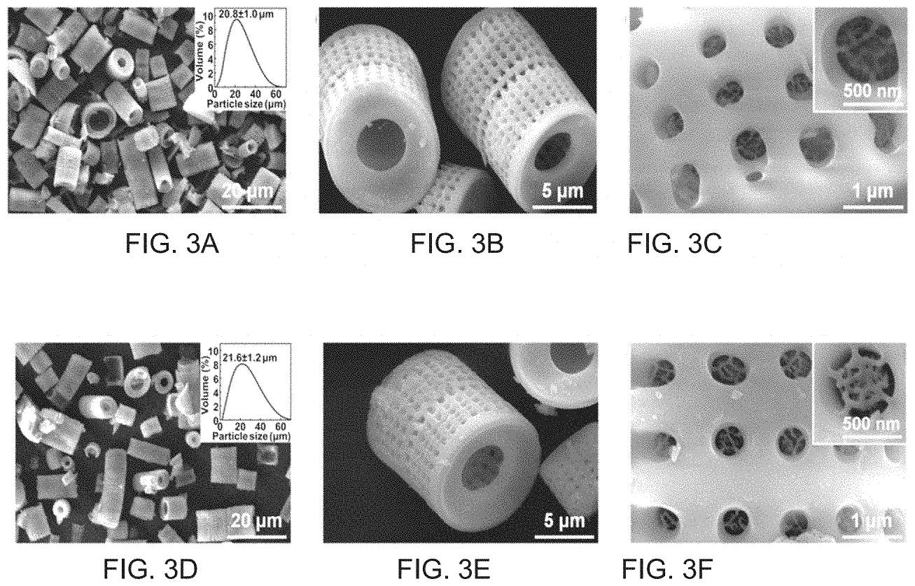

As shown in the scanning electron microscopic (SEM) images (FIGS. 3A-3C), the diatomite particles displayed relatively uniform cylindrical shape, with length of 15-20 μm and diameter of 5-10 μm. The cylinders also had hierarchical pore structure on their walls (originated from the sieve plate tissue of diatom cell), in which each large pore of ˜500 nm consisting of a network with nanorods with diameter of dozens nanometer. After magnesiothermic reduction, the D-Si samples still retained the cylinder-shape and hierarchical pore structure. For example, D-Si-6 showed a particle length of 21.6±1.2 μm (FIGS. 3D-3F) with nearly the same morphology as the original diatomite. These pores could enhance electrolyte diffusion inside the bulk electrode and buffer Si volume expansion during charge/discharge process. Due to their large particle size and hierarchical pores, the D-Si powder showed high tap density (0.9-1.1 g cm⁻³) (Table 1), a characteristic required for practical cell fabrication but difficult to achieve by previous nanostructured Si anodes.

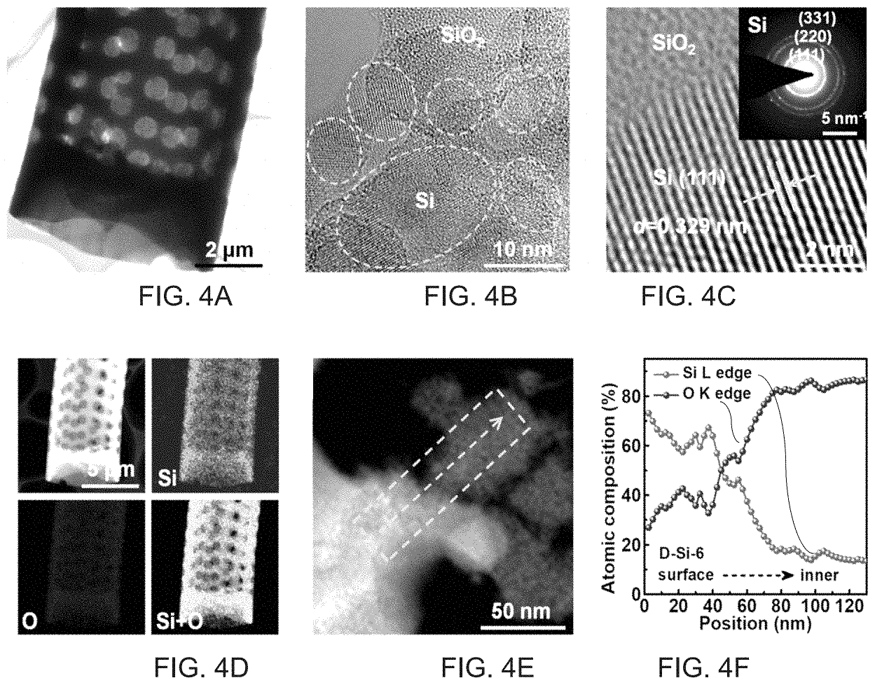

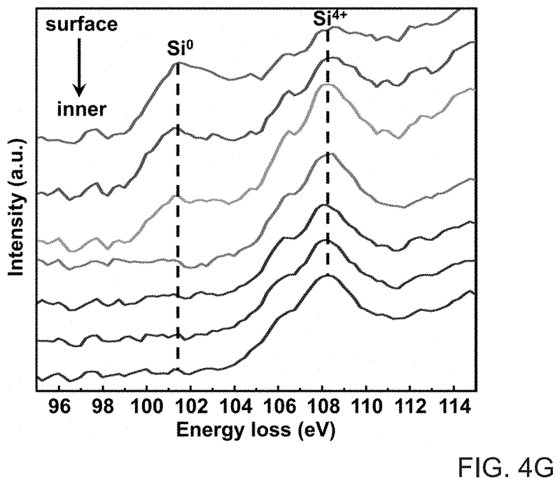

Transmission electron microscopic (TEM) image further exhibited uniform pore structure in the cylinder wall of the diatomite particles. High-resolution TEM (HR-TEM) showed their amorphous nature. After thermal reduction, the D-Si samples still maintained their uniform cylinder structure (FIG. 4A) and the crystalline Si domains were generated (FIGS. 4B, 4C). For example, D-Si-6 (FIG. 4B) presented randomly oriented crystalline domains embedded within an amorphous network, further confirming the mixed phase of Si and SiO₂. The crystalline Si domains showed a size distribution at 10-30 nm, which is consistent with the XRD results. Their high crystallinity was further shown by their clear lattice fringes with a d-spacing of 0.329 nm (FIG. 4C), which can be assigned to the (111) plane of the cubic Si (c-Si). Selected area electron diffraction (SAED) patterns of Si nanocrystalline domains (inset in FIG. 4C) with diffraction rings associated to the (111), (220), and (311) planes indicate the polycrystalline nature of the D-Si samples. Elemental mapping images (FIG. 4D) showed the uniform distribution of Si element on the surface of the D-Si-6 particles. Further, electron energy loss spectroscopy (EELS) (FIGS. 4E-4G) showed that the abundancy of Si⁰ decreased from the surface region to the inner side of the particle, while the oxygen abundancy increased. This result was expected as the solid-state magnesiothermic reduction (from Si⁴⁺ to Si⁰) proceeds from the surface to the inner side of the particles, such that the abundancy of Si⁰ decreased from the surface region to the inner region of sample It thus confirmed that the D-Si samples were obtained with partial reduction. Such a heterogenous structure is beneficial for long-term electrode cycling as the local SiO₂ network can mitigate the structure change from charge/discharge of the nanocrystalline Si.

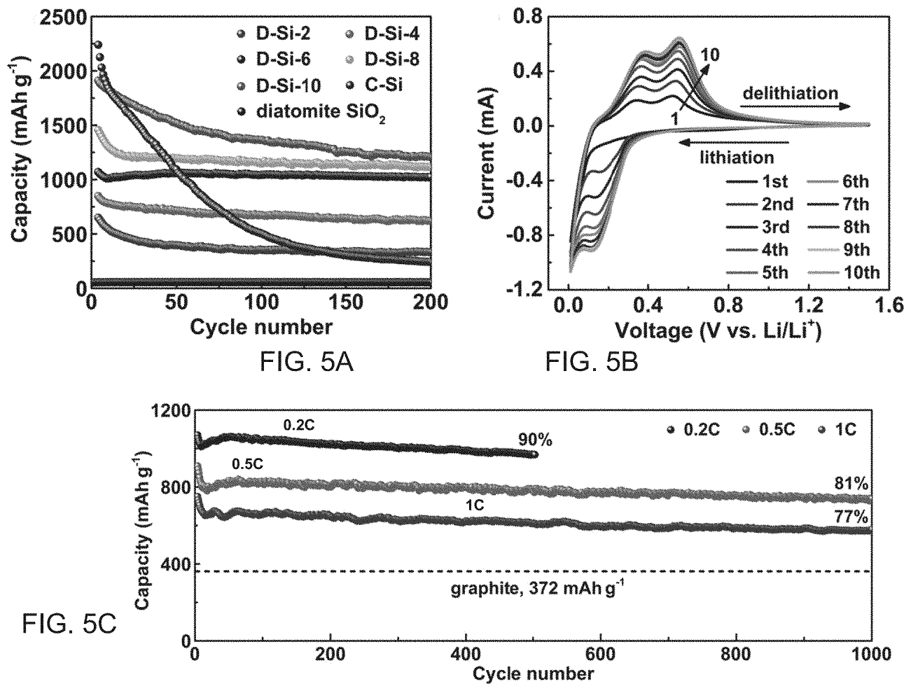

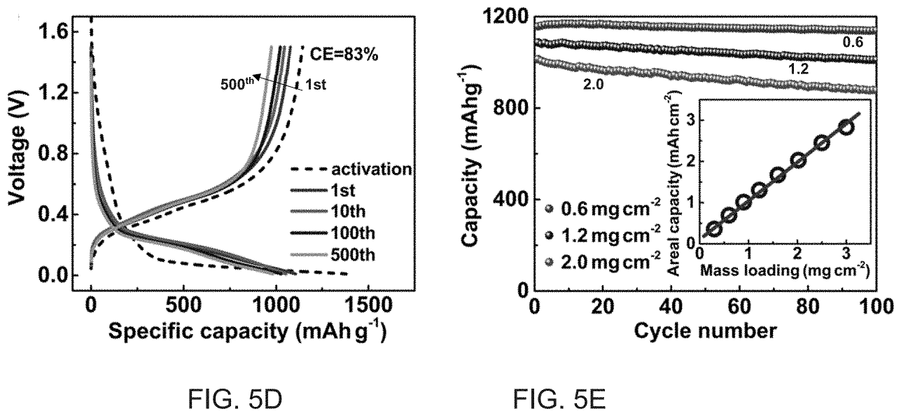

Electrochemical performance of all the Si samples was examined to identify the optimal Si/SiO₂ composition. Galvanostatic charge/discharge cycling showed distinct capacity and stability of different D-Si samples (FIG. 5A). D-Si-2 and D-Si-4 showed good stability while the capacity was low due to the presence of a too large amount of residual SiO₂ which is electrochemically inactive. D-Si-8 and D-Si-10 provided much higher capacity but their stability was relatively poor, suggesting that the smaller amount of residual SiO₂ is not able to maintain the structure stability. The D-Si-6 electrodes exhibited a high discharge capacity of ˜1000 mAh g⁻¹ (about 3 times of commercial graphite anode) at 0.2 C with nearly no capacity decay after 200 charge/discharge cycles. This result demonstrated the importance and effectiveness of tailoring the composition of Si and SiO₂ to achieve both high electrochemical activity and good stability. As expected, the diatomite precursor did not show any capacity due to their poor conductivity. While the 800 nm C-Si showed high initial capacity, their stability was poor due to the dense nonporous particle structure.

Cyclic voltammetry (CV) test was conducted at 0.2 mV s⁻¹ to further probe the electrochemical characteristic of the D-Si-6 sample (FIG. 5B). In the first cathodic scan, a strong peak at ˜0.01 V could be attributed to the lithiation of c-Si to form amorphous-Li₁₅Si₄ phase (a-Li₁₅Si₄) and subsequent cubic Li₁₅Si₄ phase (c-Li₁₅Si₄). In the anodic cycles, two peaks at approximately 0.36 and 0.54 V can be assigned to delithiation of LiₓSi alloys to amorphous-Si (a-Si). In the second and subsequent cathodic scans, new peak near 0.15 V was ascribed to reversible transformation from a-Si to LiₓSi alloy. The CV current increased gradually and then became stable, 15 suggesting the full activation of crystalline Si. These features are similar to previous reports on the mesoporous Si sponge, silicon-carbon nanotube (Si-CNT) composite, and graphene@Si nanoparticle, confirming the high electrochemical activity of the mixed Si/SiO₂ network in D-Si-6.

Despite relatively large particle size, the D-Si-6 samples showed good rate capability. The charge/discharge rate increased from 0.1 to 2 C while the discharge capacity of D-Si-6 maintained from 1160 to 490 mAh g⁻¹, which is comparable to the hierarchically porous Si nanospheres, carbon@Si nanoparticles, and self-healing binder stabilized Si. Due to different compositions, it might not be fair to compare the rate capabilities of different Si anodes. However, it is clear that at high rates, the D-Si-6 can offer similar capacity to D-Si samples with higher Si ratio and pure Si (C-Si) while providing much better cycling stability.

Extended cycling test was further conducted on D-Si-6 electrodes at rate of 0.2, 0.5 and 1 C (FIG. 5C), respectively. At 0.2 C, the electrode showed an initial Coulombic efficiency (CE) of 83%, which is among the highest values for native Si anodes. Table 2 below lists the electrochemical performance of high-performance Si anodes that have been reported in the literature relative to the diatomite Si of the present invention (indicated in bold font).

After 500 cycles, the electrode still retained a capacity of ˜970 mAh g⁻¹, corresponding to a capacity retention of 90% (FIG. 5D). Excellent cycling stability was also shown at higher rates. For example, after 1000 cycles the D-Si-6 anode can still maintain 81% and 77% of the initial capacity at 0.5 C and 1 C, respectively. The charge/discharge curves showed similar characteristics during the long-term cycling, confirming the robust electrode structure that maintained good charge transport.

As high mass loading is required for commercial applications, the areal capacity and cycling stability of D-Si-6 electrodes were tested at different mass loadings (FIG. 5E). As the mass loading increased from 0.3 to 3 mg cm⁻², the electrode areal capacity increased almost linearly from 0.36 to 2.83 mAh cm⁻² (specific capacity acquired at 0.1 C). The thick electrodes maintained good integrity without obvious cracks on electrode surface and cross-section after cycling. These results together suggest the promise in making stable thick electrodes using D-Si.

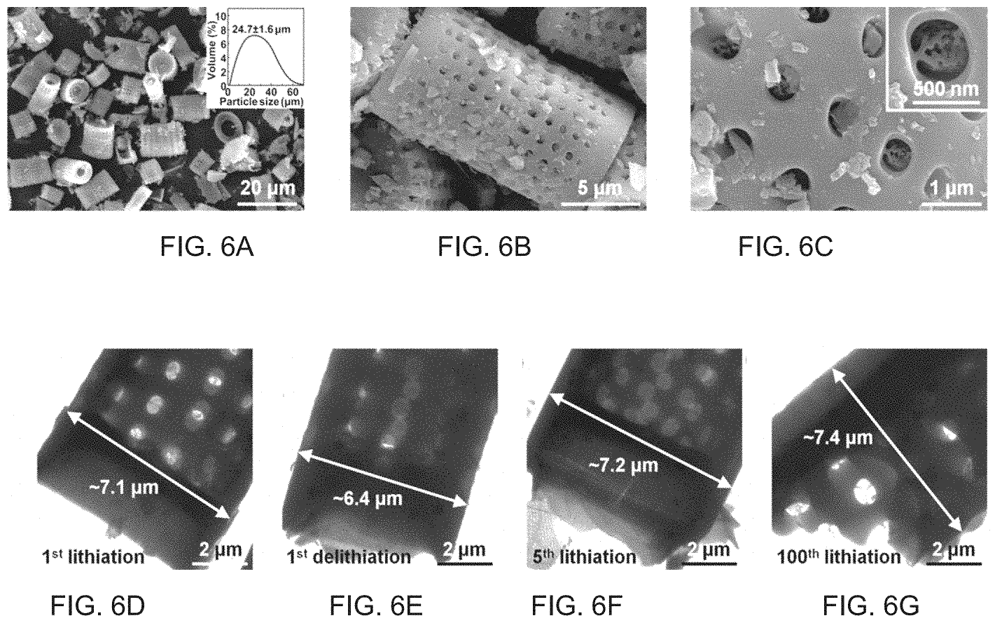

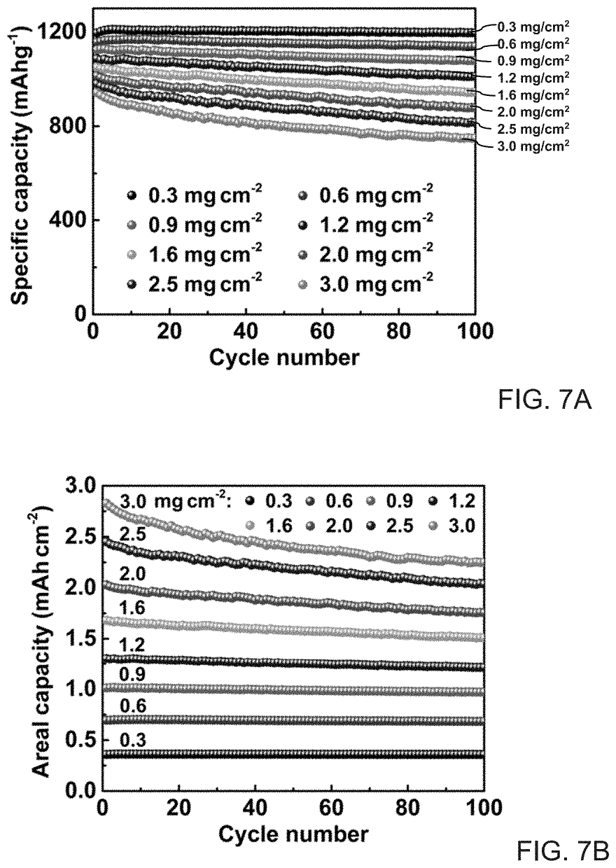

The superior cycling stability of D-Si-6 electrodes was attributed to their robust structure. After 5 cycles of lithiation at 0.1 C, most of the particles maintained their original porous cylinder structure, as shown in FIGS. 6A-6 C. Despite the Si volume expansion, their average particle sizes increased by only ˜15% (24.7±1.6 μm) compared to the pristine D-Si-6 particles, suggesting a high tolerance of the particles to volume changes. TEM images further showed similar morphology of D-Si-6 particles before (FIG. 4A) and after (FIG. 6D) lithiation. HR-TEM studies revealed the existence of polycrystalline LiₓSi alloy within the amorphous SiO₂ for the lithiated D-Si-6. Amorphous Si was formed after delithiation, consistent with earlier reports in the literature. After delithiation, the expanded cylinder particle slightly shrank without obvious morphology change (FIG. 6E). Even after 100 cycles, the particles still maintained the original hierarchical porous cylindrical structure (FIGS. 6F-6G). Due to the large particle size (˜20 μm) and relatively high tap density (0.9 g cm⁻³), the D-Si-6 electrode presented a high volumetric capacity of ˜1400 mAh cm⁻³ at 0.1 C with a mass loading of 1.6 mg cm⁻² (FIGS. 7A-7B) (corresponding to a gravimetric capacity of ˜1000 mAh g⁻¹ and electrode thickness of 11.3 μm, much higher than that of commercial graphite anode (˜600 mAh cm⁻³). Even at a large mass loading (e.g., >2 mg cm⁻²), the D-Si-6 anode still maintained relatively high capacity retention over 100 cycles (e.g., 79-86%) without using any special binder, protective coating or prelithiation.

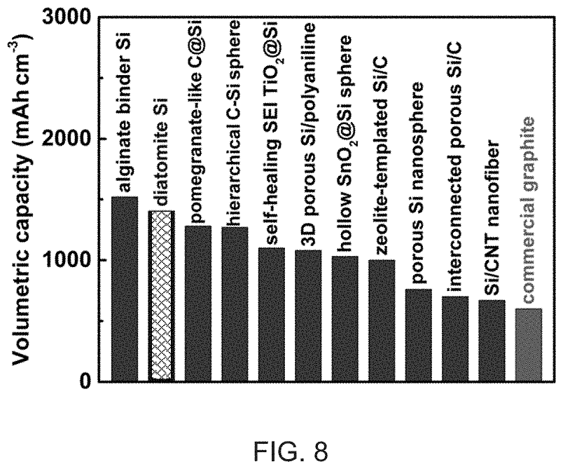

FIG. 8 summarizes the volumetric capacities, and Table 2 lists electrochemical performance of high-performance Si anodes recently reported in the literature for further comparison. Among these state-of-the-art electrodes, the diatomite Si (indicated with cross-hatching) exhibited superior volumetric capacity, 1^{st} cycle CE and capacity retention.

TABLE 2

| | | 1^{st} | Reversible | |
|---|---|---|---|---|
| | Loading | cycle | Cₘ | Cycling |
| Si anode | (mg cm⁻²) | CE | (mAh g⁻¹) | number/retention |
| diatomite Si | 0.6 | 83% | 970 | 500, 90% |
| | 1.6 | 83% | 940 | 100, 89% |
| zeolite Si | 1 | 81.7 | 800 | 1000, 40% |
| hierarchically porous Si sphere | 0.8 | 52% | 1850 | 200, 92% |
| 3D macro-/mesoporous Si | 1.4 | 62.5% | 950 | 300, 56% |
| mesoporous Si sponge | 0.5 | 56% | 750 | 1000, 80% |
| Si with pulley-polyrotaxane binder | 1 | 91.2% | 1480 | 400, 75% |
| Si with self-healing binder | 0.6 | 80% | 1800 | 130, 74% |
| Si with gel polymer electrolyte | 3.7 | 65% | 1060 | 200, 86% |
| graphene cage@Si | 0.8 | 93% | 1300 | 300, 85% |
| pomegranate-like C@Si | 0.2 | 90% | 1160 | 1000, 97% |
| ant-nest-like C@Si | 0.8 | 80.3% | 1270 | 1000, 90% |
| zeolite-templated C/Si | 1.5 | 73.1% | 700 | 300, 83% |
| TiO₂@Si | 0.8 | 65.8% | 990 | 1500, 75% |
| with self-healing SEI | | | | |
| hollow SnO₂@Si nanosphere | 1.9 | 62.6% | 770 | 500, 64% |

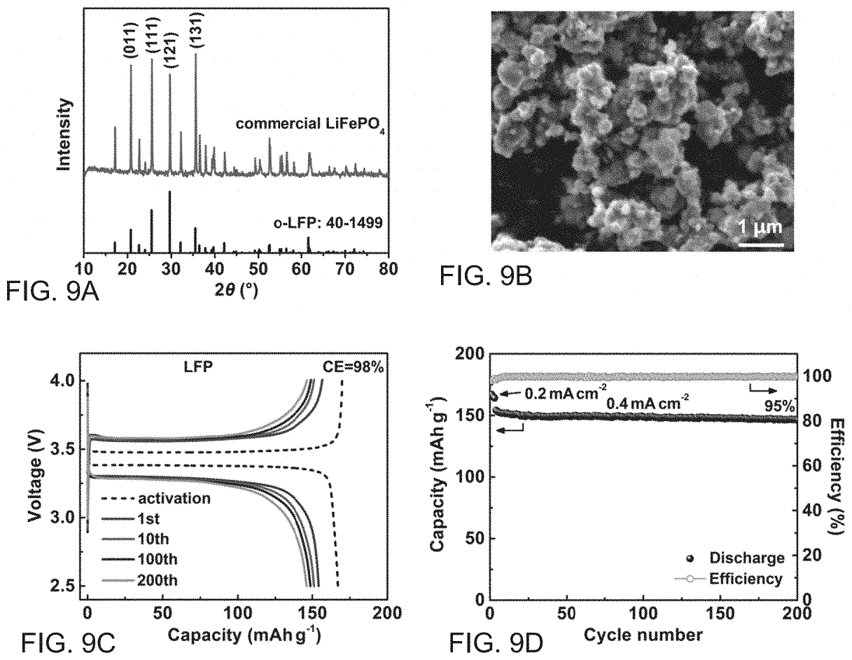

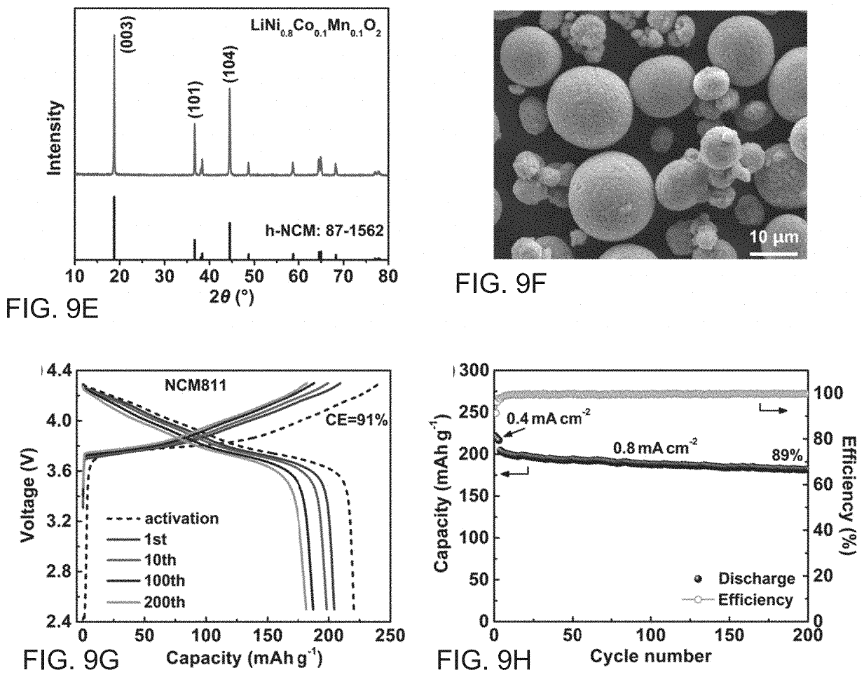

Full cell application was further demonstrated using D-Si-6 as the anode and LiFePO₄ (LFP) (FIGS. 9A-9D) or LiNi_{0.8}Co_{0.1}Mn_{0.1}O₂ (NCM811) (FIGS. 9E-9H) as the cathode. FIGS. 9A-9B show an XRD pattern and a SEM image, respectively, of commercial LiFePO₄ sample (MTI Cooperation). FIGS. 9C-9D plot cycling performances of LFP cathode at 0.4 mA cm⁻² (0.5 C for 5 mg cm⁻² of LFP), where FIG. 9C provides charge/discharge curves, and FIG. 9D plots cycle stability and Coulombic efficiency, of LFP electrodes for 200 cycles. The commercial LFP powder displayed typical olivine structure, with uniform particle size of 200-300 nm. During continuous cycling at 0.4 mA cm⁻², the LFP cathode expressed apparent lithiation and delithiation plateau of 3.55 and 3.3 V, with initial and subsequent Coulombic efficiency of 98% and ˜100%. Over 200 cycles, its specific capacity was recorded as ˜150 mAh g⁻¹, showing high capacity retention of 95%. FIGS. 9E-9F show an XRD pattern and SEM image, respectively, of a commercial LiNi_{0.8}Co_{0.1}Mn_{0.1}O₂ sample (MTI). FIGS. 9G-9H plot cycling performances of NCM811 cathode at 0.8 mA cm⁻² (0.3 C for 15 mg cm⁻² of NCM811), where FIG. 9G provides charge/discharge curves and FIG. 9H show cycle stability and Coulombic efficiency of NCM811 electrodes for 200 cycles. The commercial NCM811 cathode exhibited the hexagonal phase (space group R^{3̅} m) with microspherical structure. During continuous cycling at 0.8 mA cm⁻², the NCM811 cathode presented lithiation/delithiation voltage of 3.7-4.3 V, with initial and subsequent Coulombic efficiency of 91% and ˜99%. Over 200 cycles, its specific capacity was recorded as ˜180 mAh g⁻¹, corresponding to a capacity retention of 89%.

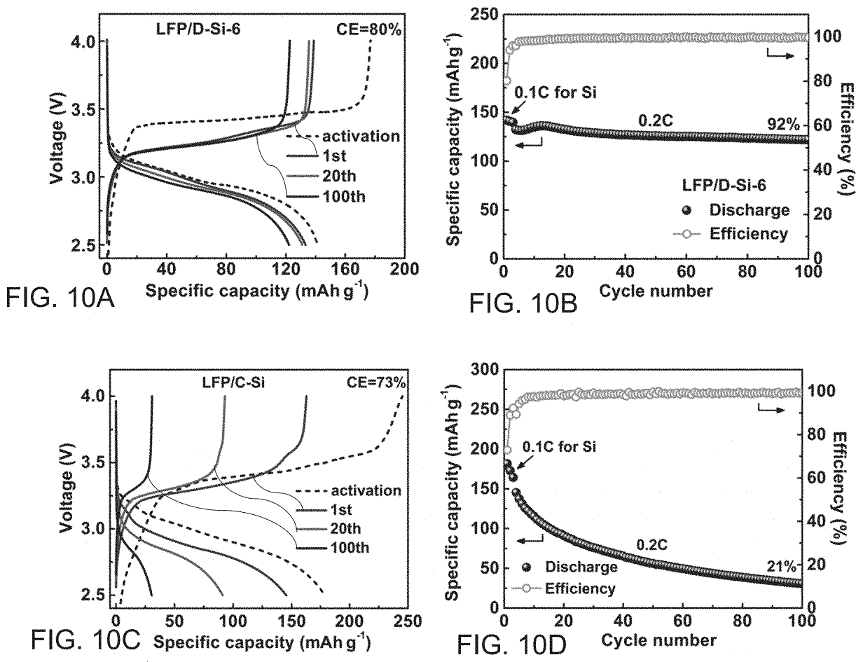

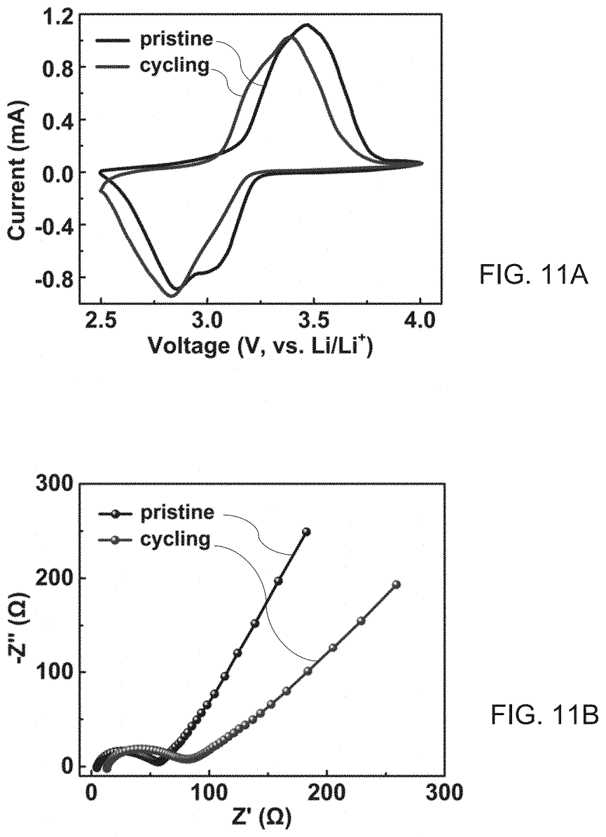

The LFP/D-Si-6 cell (3.8 mg cm⁻² LFP cathode and 0.6 mg cm⁻² D-Si-6 anode) at 0.4 mA cm⁻² offers a discharge voltage window of 3.3-2.5 V at a charge/discharge rate of 0.2 C. Even without any prelithiation, a high initial CE of ˜80% was achieved (FIG. 10A). By comparison, the initial CE of the full cell using C-Si (6 mg cm⁻² LFP cathode and 0.6 mg cm⁻² C-Si anode) at 0.4 mA cm⁻² was only 73% (FIG. 10C). The LFP/D-Si-6 full cell showed specific capacity of ˜140 mAh g⁻¹ (based on the total mass of anode and cathode), with a high capacity retention of 92% after 100 cycles (FIG. 10B), much higher than that of the C-Si-based full cell (21% of capacity retention (FIG. 10D). The superior full cell cycling stability was further confirmed by CV and electrochemical impedance spectroscopy (EIS) measurements, which showed well-maintained redox peaks and overall cell impedance before and after cycling (FIGS. 11A-11B). The CV curves in FIG. 11A showed similar redox peaks before and after cycling, indicating the good reversibility of LFP/D-Si-6 full cell. From the EIS curves in FIG. 11B, for overall cell, the semicircle (Faradic charge-transfer resistance) of cycling cell became a little larger, and the tilt rate of straight line (Warburg impendence) was still close to ˜45°, signifying its fast transport of lithium ions and electrons in electrode/electrolyte interface

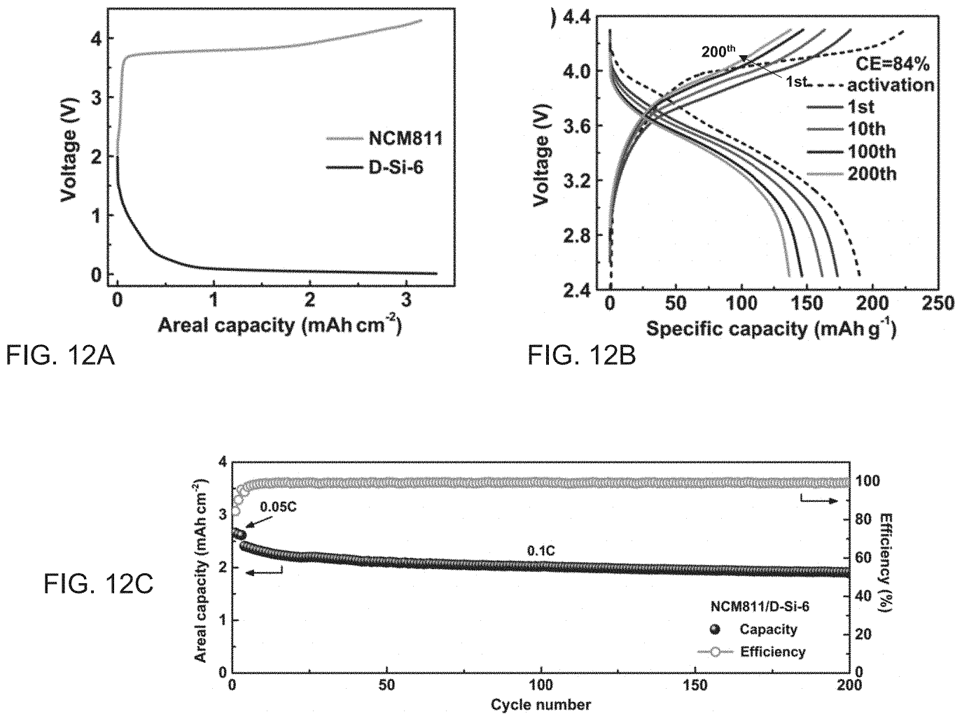

Interestingly, the NCM811 cathode and D-Si-6 anode paired to show ideal charging behavior for a high energy full cell (FIG. 12A). The full cell offered a specific capacity of ˜190 mAh g⁻¹ (based on the total mass of anode and cathode) at 0.05 C, with a discharge voltage window of 4.2-3 V and an initial CE of ˜84% (FIG. 12B). After 200 cycles, the full cell still retained 78% of its initial capacity at 0.1 C rate and areal capacity of ˜1.91 mAh cm⁻² (FIG. 12C). At average working voltage of ˜3.8 V, the full cell can provide a high energy density of 722 Wh kg⁻¹ (based on cathode and anode active materials only). Such a specific capacity and cycling stability are comparable to or better than the best-performing NCM811/Si full cells reported recently.

The above structure characterization and electrochemical test together confirmed the high specific capacity and structure stability of D-Si anode during long-term cycling. While the current full cell demonstration was performed in coin cell with limited areal capacity, we believe the properties of D-Si can be readily translated to large cells (e.g., pouch cells) by engineering cell designs. With optimization of the cathode composition and mass loading, as well as applying anode prelithiation, we believe the full cell performance can be further improved. Carbon coating can be also applied to the D-Si-6 to further improve the 1st cycle CE and long-term stability.

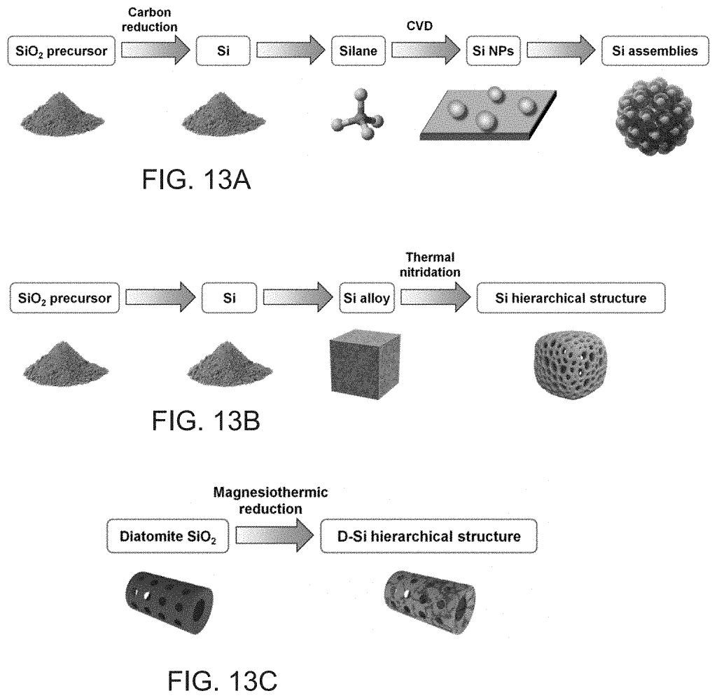

Advantages of the inventive approach towards stable Si anode can be further highlighted from both the design and synthesis perspectives. Micron-sized particles with porous structure are preferred for Si anode as they offer high structure stability without sacrificing tap density, which is a critical need for practical cell applications but often overlooked in the previous design of nanostructured Si anode. The selection of diatomite as both a precursor and a template to generate a desired hierarchical porous Si structure provides significant advantages in terms of mass production compared to previous approaches (FIGS. 13A-13C). More specifically, the state-of-the-art hierarchically assembled Si nanostructures rely on the preformed Si nanoparticles (e.g., <100 nm), which is often synthesized from plasma-enhanced chemical vapor deposition (CVD) using silane as the precursor and Au, Pt or Cu as the metal catalyst. Note that silane is made from acid-base chemical reaction with silicon alloy, and silicon is produced by reducing silica (SiO₂) by carbon at high temperature (metallurgical crude Si). Such a complicated process inevitably results high cost which is prohibitive for commercial application. By contrast, our D-Si is made by one-step reduction from diatomite without complicated chemical process, which holds a potential for scale up at low cost.

A simple economic analysis was performed to estimate the production cost of D-Si, including the diatomite, Mg, HCl, water, Ar and power. The results are provided in Table 3.

TABLE 3

| | | | |
|---|---|---|---|
| Items | Unit price | Consumption | Cost ($) |

| | | | | | |
|---|---|---|---|---|---|
| Diatomite | 0.3 | $kg⁻¹ | 1.43 | kg | 0.43 |
| Mg | 1.8 | $kg⁻¹ | 1.14 | kg | 2.06 |
| HCl | 0.1 | $kg⁻¹ | 3.0 | kg | 0.30 |
| Water | 0.4 | $t⁻¹ | 0.05 | t | 0.02 |
| Ar | 2.5 | $m⁻³ | 0.2 | m³ | 0.50 |
| Power | 0.3 | $kWh⁻¹ | 18 | kWh | 5.40 |

| | | | |
|---|---|---|---|
| Total | — | — | 8.71 |

Taking into account the short synthesis process, the gross cost of D-Si-6 was calculated as ˜8.7 $kg⁻¹. Although the cost is a bit higher than the price of commercial metallurgical crude Si (1-2 $kg⁻¹), the metallurgical Si cannot be utilized directly as the anode material due to its high impurities (e.g., Fe, Ca). Further, the D-Si product is much lower cost than the CVD grade Si (50-100 $kg⁻¹), which is commonly used as the electrode material in the lab-scale test. For real world applications, such a low cost can put the D-Si anode on par with the commercial graphite (10-20 $kg⁻¹), while the D-Si anode can provide about 3 times capacity of the state-of-the-art graphite anode.

The inventive approach provides a simple and sustainable method to synthesize microscale hierarchical porous Si anode material with unique Si/SiO₂ network from nature-abundant, low-cost diatomite precursor. Such unique structure provides very high stability during charge/discharge cycle in LIB anodes. By adjusting the reduction conditions, the optimal Si/SiO₂ anode material (D-Si-6) can deliver a high reversible capacity of ˜970 mAh g⁻¹ (about 3 times of commercial graphite) after repeated cycling for 500 cycles at 0.2 C with a capacity retention as high as 90%. The electrodes can also maintain 81% and 77% of their initial capacity over 1000 cycles at 0.5 C and 1 C, respectively. A full cell based on LFP or NCM811 cathode and the D-Si-6 anode demonstrated the specific capacity of 140 or 190 mAh g⁻¹ (based on the total mass of anode and cathode) and with a high capacity retention of 92% (100 cycles) or 78% (200 cycles), respectively. These results demonstrate the significant advantages of the inventive diatomite-derived hierarchical porous Si/SiO₂ network as a high-performance and low-cost anode for LIBs.

The following examples describe methods and procedures used in preparation and testing of the inventive materials.

### EXAMPLE 1: PREPARATION OF SILICON (DIATOMITE PRECURSOR)

In a typical synthesis, 1 g of diatomite (DiatomaceousEarth, food grade) and 0.8 g of Mg chips (Sigma-Aldrich, 99%) was mixed uniformly in a mortar and pestle, before being placed in a home-made titanium boat. The mixture was heated to a temperature of 650° C. in a tube furnace (Thermo Scientific, Lindberg Blue M) under argon (Ar) atmosphere for different time (2, 4, 6, 8 or 10 h) to control the ratio between the Si and SiO₂ constituents. The crude product mixtures were immersed into 2 M HCl for 10 h to remove impurities (e.g., Mg₂Si, MgO, etc.). The precipitates were washed thoroughly with deionized water. Brown color products were obtained after vacuum drying at 60° C. for 1 h. The diatomite-derived hybrid Si/SiO₂ samples were labeled according to their reduction time (“D-Si—X”). For example, Si/SiO₂ sample prepared by 2 h of reduction was labeled as D-Si-2. As a control, a commercial Si (C-Si) from MTI with average particle size of ˜800 nm was used as a benchmark.

### EXAMPLE 2: CHARACTERIZATION

X-ray diffraction (XRD) was measured using Cu-Kα radiation (Bruker, D2 Phaser, λ=0.154 nm) with a step of 0.02°. Porosity was determined using adsorption-desorption of liquid N₂ at −196° C. (Quantachrome, Autosorb-IQ), giving specific surface area from the Brunauer-Emmett-Teller (BET) method (SBFT) and pore size distribution from the density functional theory (DFT). Phase compositions were examined by Raman spectrometry (Thermo Scientific, DXR Microscope) at excitation wavelength of 532 nm. Surface compositions were performed using X-ray photoelectron spectroscopy (XPS, Kratos, AXIS Ultra DLD) with Al Kα radiation. Morphologies were investigated by a FEI Quanta-250 scanning electron microscopy (SEM) with accelerating voltage of 10 kV and FEI Talos F200X high resolution transmission electron microscopy (HR-TEM) of 200 kV.

### EXAMPLE 3: ELECTROCHEMISTRY

For half cells, working electrodes were made of 60 wt % of Si, 20 wt % of super P (Timcal), and 20 wt % of binder (carboxymethyl cellulose sodium (CMC) with polyacrylic acid (PAA), 4 wt % CMC+4 wt % PAA in solution of H₂O/ethanol). The slurry was casted onto a Cu foil and then dried in vacuum oven. The samples were then cut into ˜1 cm² disks with Si mass loading of 0.3-3 mg cm⁻² and pressed by rolling. Li metal was used as counter electrode. For full cells, lithium iron phosphate (LiFePO₄, LFP, MTI) or lithium nickel cobalt manganese oxide (LiNi_{0.8}Co_{0.1}Mn_{0.1}O₂, NCM811, MTI) was used as the cathode. The theoretical capacity was considered at 172 and 200 mAh g⁻¹ for LFP and NCM811, respectively. The cathode was made of 80 wt % of LFP or NCM811, 10 wt % of super P, and 10 wt % of polyvinylidene fluoride (PVDF) in N-methyl pyrrolidone (NMP). The slurry was casted onto an Al foil and dried in vacuum oven. CR2032-type coin cells were assembled in an argon-filled glove box, with a Celgard 2400 separator. All the Si electrodes were heated at 150° C. for 30 min to make the CMC-PAA binder become cross-linked. The electrolyte was 1 M LiPF₆ in ethylene carbonate (EC) and diethyl carbonate (DEC) (BASF, LP40, EC:DEC=1:1 in w/w) with 5 wt % of fluoroethylene carbonate (FEC) and 5 wt % of vinylene carbonate (VC). Cyclic voltammetry (CV) and electrochemical impedance spectroscopy (EIS, 0.1-104 Hz) were performed on a Metrohm workstation (Autolab). Galvanostatic discharge/charge performances were measured on a Neware battery testing system (CT-ZWJ-4S-T), cycling between 0.01-1.5 V for Si half-cell, 2.5-4.0 V for LFP/D-Si-6 full cell or 2.5-4.3 V for NCM811/D-Si-6 full cell. The N/P ratio of (capacity ratio between anode and cathode) full cell was 1.05. All of cells were tested at 25±1° C. Capacity were calculated at gravimetric capacity (Cₘ, mAh g⁻¹), areal capacity (Cₛ, mAh cm⁻²) and volumetric capacity (Cᵥ, mAh cm⁻³).

### EXAMPLE 4: MONTMORILLONITE PRECURSOR

Using a controlled magnesiothermic reduction process, the main component of SiO₂ in montmorillonite was converted into nanoscale crystalline-amorphous network consisting of Si and SiO₂, respectively. The as-prepared Si/SiO₂ composite maintained the layered structure (void) and generated high density of nanopores on its surface. Such the parallel layer array can mitigate volume expansion of Si crystal. As a result, the Si anode based on above composite structure showed both high capacity and excellent cycling stability, demonstrated in both half and full cells with industrially relevant mass loading. This approach exploits microscale Si structure to simultaneously achieve high tap density (0.9-1.0 g cm⁻³) and excellent cycling stability. Such monolithic Si can show a particle size and tap density similar to today's commercial graphite anode, which can be critical for the actual production.

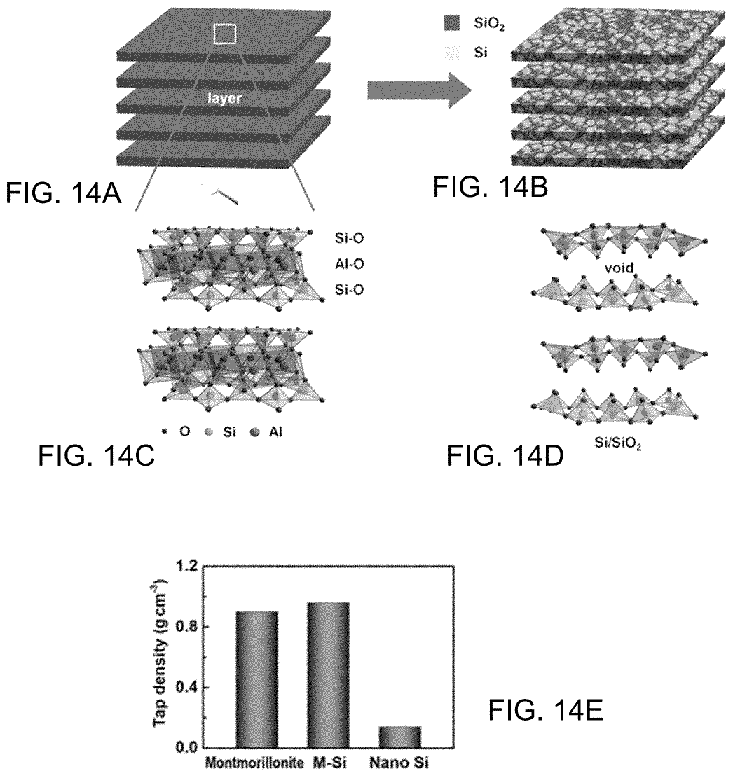

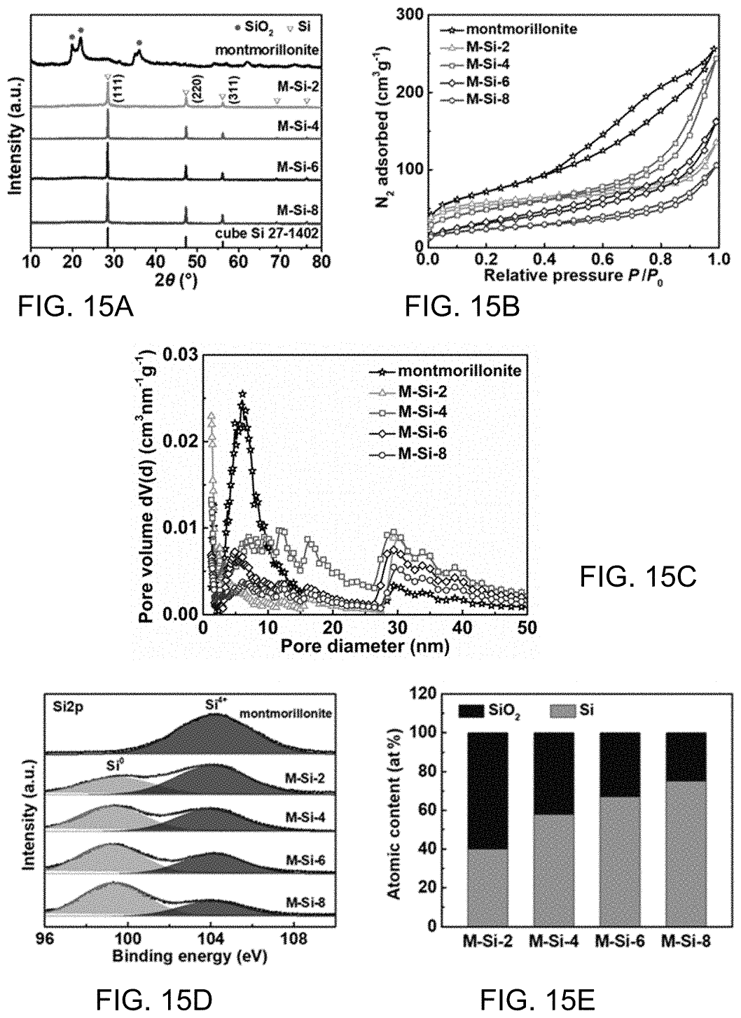

FIGS. 14A-E diagrammatically illustrate characteristics of montmorillonite SiO₂ (FIG. 14A) and montmorillonite-derived Si/SiO₂ (FIG. 14B). FIGS. 14B & 14D show the micro-structure of the two materials. FIG. 14F provides a comparison of tap density for montmorillonite, montmorillonite-derived Si, and nano silicon. FIG. 15A presents the X-ray diffraction (XRD) patterns of the pristine montmorillonite and montmorillonite-derived Si (denoted as “M-Si”) samples. The montmorillonite shows three peaks located at 2θ of 19.9°, 21.9° and 36.0°, corresponding to the amorphous SiO₂. After Mg reduction, diffraction peaks at 28.4°, 47.3°, 56.1°, 69.1° and 76.4° in M-Si patterns were attributed to the (111), (220), (311), (400) and (331) planes of cubic Si (JCPDF No. 27-1402), respectively. With reaction time prolonged from 2 to 8 h, the intensities of such characteristic peaks increased, suggesting the continuous development of Si domains. Using the Scherrer equation, the corresponding grain size (D) of these M-Si samples grew from 36.2 to 58.4 nm.

The nitrogen adsorption-desorption isotherms of the montmorillonite and M-Si are shown in FIG. 15B. All isotherms of five samples were the type IV with an obvious hysteresis loop, ascribing to the mesoporous structure (2-50 nm). The original montmorillonite exhibited a large N₂ update, suggesting its high Brunauer-Emmett-Teller (BET) specific surface area (213 m² g⁻¹). At the reduction time of 4 h, the M-Si-4 sample revealed the largest BET surface area of 137 m² g⁻¹. While the surface area of M-Si sample decreased under the prolonged time, the M-Si-8 had only 58 m² g⁻¹ (Table 4). This is likely caused by the collapsing or widening of pores during the long-term heating process. In this case, the average pore size (dₐ) increased from 12.7 (M-Si-2) to 14.2 nm (M-Si-8) (Table 4). According to the pore size distributions in FIG. 15C, all the M-Si samples showed hierarchical pore structure of mesopores and micropores (<2 nm). Such the hybrid porous structure is beneficial to fast transport of Li ions into electrode.

TABLE 4

| | D | S_{BET} | Vₜ | dₐ | Si⁰ | Tap density |
|---|---|---|---|---|---|---|
| Samples | (nm) | (m² g⁻¹) | (cm³ g⁻¹) | (nm) | (at %) | (g cm⁻³) |
| Montmorillonite | — | 213 | 0.472 | 8.9 | 0 | 0.90 |
| M-Si-2 | 36.2 | 80 | 0.253 | 12.7 | 40 | 1.01 |
| M-Si-4 | 43.5 | 137 | 0.457 | 13.3 | 58 | 0.96 |
| M-Si-6 | 50.7 | 91 | 0.314 | 13.8 | 67 | 0.99 |
| M-Si-8 | 58.4 | 58 | 0.206 | 14.2 | 75 | 1.04 |

The X-ray photoelectron spectroscopy (XPS) spectra of the montmorillonite and M-Si samples showed apparent peaks of O (533 eV), C (284.6 eV) and Si (154 and 103 eV) element. The montmorillonite showed a significant Si2p peak at approximately 103 eV, ascribing to the valence of Si⁴⁺ in SiO₂. For all the M-Si samples, a new peak located at ˜98.5 eV, which was attributed to the formation of Si⁰ composition (FIG. 15D). The relative atomic content of Si⁰ (Si⁰/Si⁴⁺+Si⁰) for M-Si-2 to M-Si-8 was determined as 40, 58, 67 and 75 at %, respectively (FIG. 15E). The results verified the longer reduction time led to the more Si⁰ in M-Si sample.

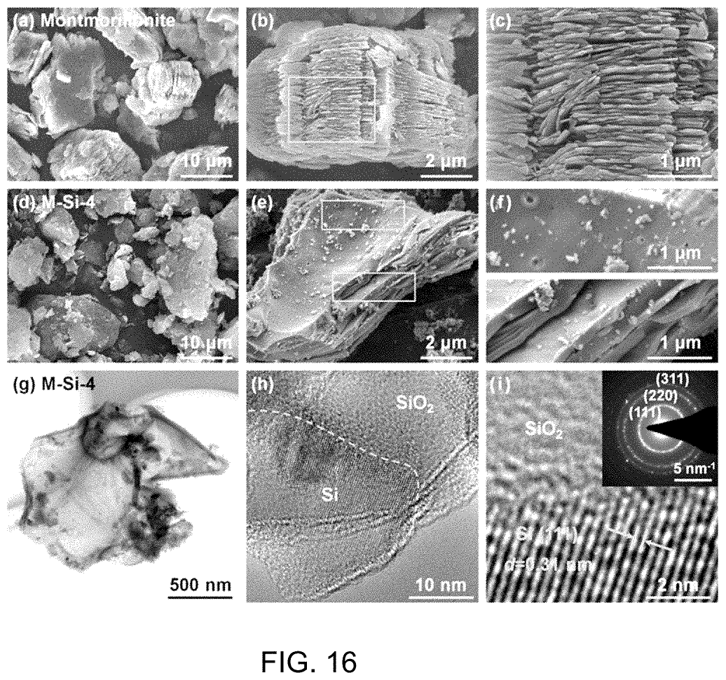

Referring to the scanning electron microscopy (SEM) images of FIG. 16, panel (a) shows that the pristine montmorillonite particles displayed micron-sized monolithic shape with particle size of 10-20 μm. Such particle contained hundreds of layered nanosheet structure, seen in panel (b), which one layer with thickness of several nanometers, shown in panel (c). The M-Si-4 sample still retained the monolithic-shape with layer structure after thermal reduction, seen in panels (d) and (e). Due to the removal of some metal oxides, there were numerous pores on the surface of particle, visible in panel (f). These pores could enhance electrolyte diffusion inside the bulk electrode and buffer volume expansion of Si during lithiation process. Due to the micron-scale monolithic particle, the M-Si powder revealed large tap density of ˜1 g cm⁻³, an important parameter with respect to industrial battery fabrication but difficult to achieve by previous nanostructured Si materials (Table 4).

Still referring to FIG. 16, the transmission electron microscopy (TEM) image in panel (g) presented obvious sheet shape and pore structure of the M-Si sample. High-resolution TEM (HR-TEM) in panels (h) and (i) revealed the mixed phase of Si/SiO₂, which the randomly oriented crystalline Si domains (40-50 nm) embedded within the amorphous SiO₂ network. The Si domains exhibited clear lattice fringes with a spacing of 0.31 nm, assigning to the (111) plane of cubic Si. Diffraction rings in selected area electron diffraction (SAED) patterns (inset in panel (i)) could be attributed to the (111), (220) and (311) planes of Si nanocrystals, indicating the polycrystalline nature of M-Si. Further, elemental mapping exhibited a uniform distribution of Si element on the surface of the M-Si-4 sheet. A line scan indicated that the abundancy of Si decreased from the surface region to the inner side of the particle, while the O abundancy increased. This result further confirmed the solid-state magnesiothermic reduction proceeds from the surface to the inner side of the precursor. Such a Si/SiO₂ network structure is beneficial for long-term cycling performance as the crystalline Si can provide Li-storage capacity and the amorphous SiO₂ can offer local structure stability.

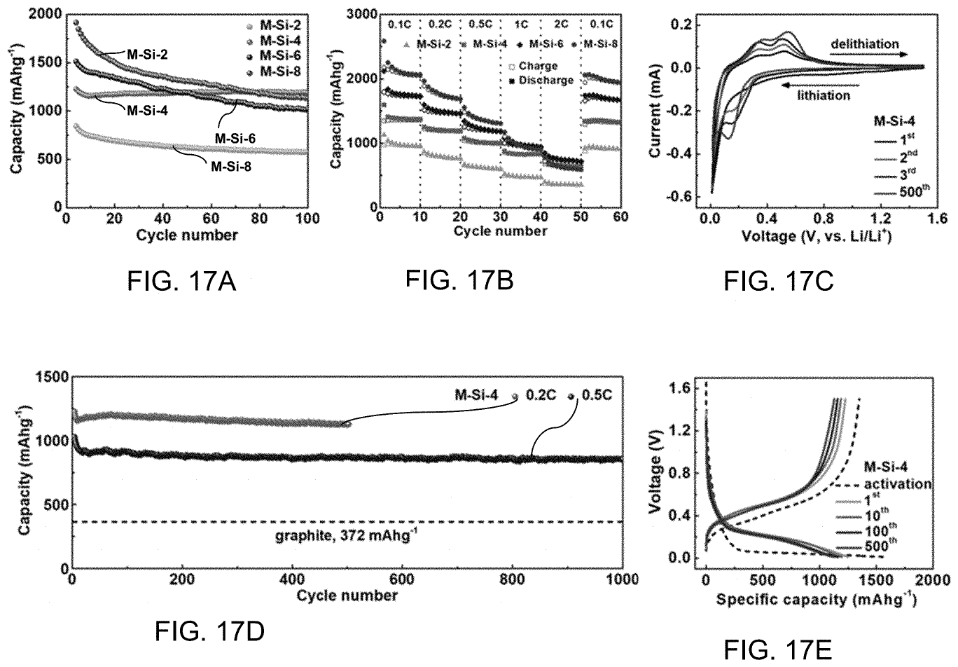

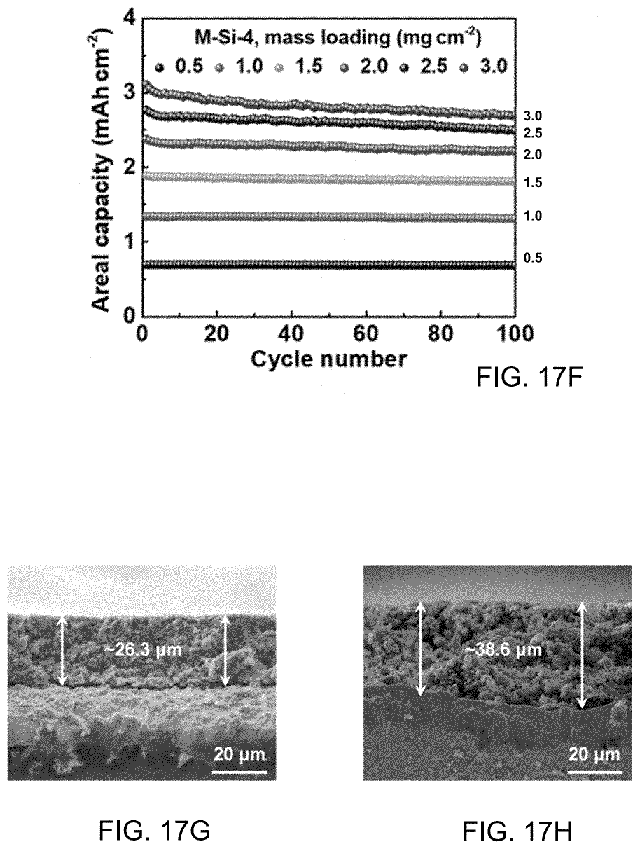

To investigate the optimal Si/SiO₂ ratio, the galvanostatic charge/discharge cycling at 0.2 C of different M-Si samples was exhibited in FIG. 17A. Due to the large amount of residual SiO₂, M-Si-2 (40 at % Si⁰) showed relatively good stability while its capacity value was low. M-Si-6 (67 at % Si⁰) and M-Si-8 (75 at % Si⁰) provided much higher capacity but their stability was poor. The M-Si-4 (58 at % Si⁰) exhibited a high charge capacity of 1200 mAh g⁻¹ (about 4 times of 372 mAh g⁻¹ for commercial graphite anode) with nearly no capacity decay after 100 cycles. It is demonstrated that the moderate Si/SiO₂ ratio of Si anode can achieve both high capacity and good stability.

The rate performances of four M-Si samples are shown in FIG. 17B. As expected, the M-Si-4 revealed the best rate capability. With the charge/discharge rate increased from 0.1 to 2 C, the charge capacity of M-Si-4 only decreased from 1350 to ˜670 mAh g⁻¹, which is comparable to the zeolite-templated C/Si, hollow SnO₂@Si, porous Si/C composite and double-shelled yolk-structured Si.

Cyclic voltammetry (CV) testing was carried out at 0.2 mV s⁻¹ to further inspect the electrochemical characteristic of the M-Si-4 sample (FIG. 17C). There was a sharp cathodic peak below 0.1 V in the first and subsequent scans, which corresponded to the lithiation of cubic Si to alloying LiₓSi phase (e.g., Li₁₅S₄). Two anodic peaks at around 0.36 and 0.54 V can be ascribed to delithiation of LiₓSi alloy to amorphous Si phase. New cathodic peak appeared near 0.16 V in the second and subsequent scans, was attributed to reversible transformation from amorphous Si to LiₓSi alloy. The CV peak intensity increased over the first three cycles due to the activation process of Si anode, which was also observed in previously reported Si-based anode materials.

Long-term cycling lifetime of the 1 mg cm⁻² M-Si-4 anode was further conducted at rate of 0.2 and 0.5 C (FIG. 17D). At 0.2 C, the electrode showed an initial Coulombic efficiency (CE) of 84%, which is the superior value for untreated Si anodes (Table 5). (Note the similar results compared to those provided in Table 2 above for diatomide-derived Si.) After 500 cycles, the anode retained a charge capacity of ˜1130 mAhg⁻¹, corresponding to excellent capacity retention of 92%. Even over 1000 cycles, the M-Si-4 anode could still maintain 83% of the initial capacity at 0.5 C, with a reversible capacity of ˜855 mAhg⁻¹. The charge/discharge curves were almost overlapped during the long-term cycling (FIG. 17E), and the CV curve showed similar characteristics after 500 cycles (FIG. 17C).

TABLE 5

| | | 1^{st} | | |
|---|---|---|---|---|
| | Loading | cycle | Capacity | Cycling |
| Si anode | (mg cm⁻²) | CE | (mAh g⁻¹) | number/retention |
| Montmorillonite-derived Si | 1.0 | 84% | 1130 | 500, 92% |
| | 3.0 | 84% | 900 | 100, 87% |
| 3D macro-/mesoporous Si | 1.4 | 62.5% | 950 | 300, 56% |
| Double-shelled yolk-structured Si | 0.8 | 74% | 700 | 1000, 84% |
| Metallurgically lithiated SiOₓ | 1.1 | 93% | 960 | 400, 90% |
| Si/MXene composite | 0.9 | 84% | 1200 | 280, 65% |
| Ant-nest-like C@Si | 0.8 | 80.3% | 1270 | 1000, 90% |
| Graphene cage@Si | 0.8 | 93% | 1300 | 300, 85% |
| C@Si nanosheet | 1.5 | 50% | 1070 | 500, 82% |
| Zeolite-templated C/Si | 1.5 | 73.1% | 700 | 300, 83% |
| Si@void@graphene | 0.6 | 85% | 1280 | 500, 89% |
| Double-shelled C@Si | 1 | 69% | 1300 | 1000, 75% |
| Nano/micro structured Si—C | 1.5 | 80% | 1120 | 500, 78% |
| Porous Si—C—graphite | 2.5 | 65% | 650 | 450, 82% |
| CNT@Si@C | 0.53 | 83% | 1300 | 1500, 87% |
| Hollow SnO₂@Si sphere | 1.9 | 62.6% | 770 | 500, 64% |

The areal capacity and cycling stability of M-Si-4 electrodes were tested at different mass loadings at a charge/discharge rate of 0.1 C. As the mass loading increased from 0.5 to 3 mg cm⁻², the electrode areal capacity increased almost linearly from 0.69 to 3.06 mAh cm⁻², with the corresponding specific capacity of 1380 to 1020 mAh g⁻¹. As can be seen in FIG. 17F, at high mass loading (e.g., 2-3 mg cm⁻²), the M-Si-4 electrode still maintained relatively large capacity retention over 100 cycles (e.g., 93-87%). Such high areal capacity and capacity retention can put the M-Si-4 anode on par with the today's commercial LIBs (>3 mAh cm⁻²). Additionally, the thick M-Si-4 electrodes still maintained good integrity without obvious cracks on electrode surface and cross-section (FIGS. 17G-17H) after cycling. These results further confirm the good stability of such M-Si anode.

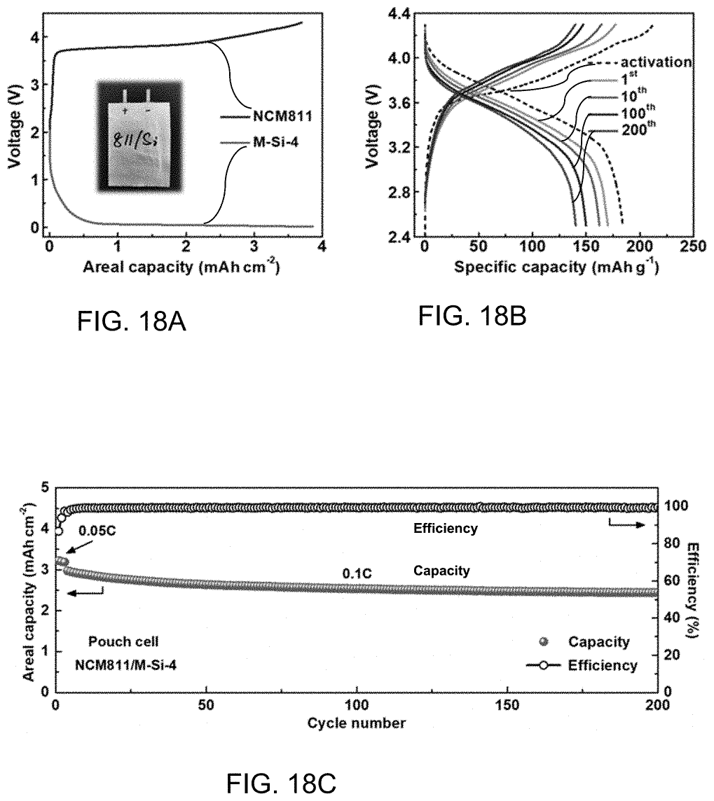

Full cell application was further demonstrated using LiNi_{0.8}Co_{0.1}Mn_{0.1}O₂ (NCM811) as the cathode and M-Si-4 as the anode. FIG. 18A exhibited the initial charge curves of NCM811 cathode and M-Si-4 anode, the large potential difference between cathode/anode suggested the high output voltage of full cell. With a discharge voltage window of 4.3-2.5 V, such a cell (NCM811/M-Si-4) gives a high initial CE of ˜87% via a simple prelithiation (FIG. 18B). The NCM811/M-Si-4 pouch cell offered a specific capacity of 184 mAh g⁻¹ (based on the total mass of cathode and anode) at 0.05 C. After 200 cycles, the full cell still delivered a reversible capacity of ˜140 mAh g⁻¹ (2.44 mAh cm⁻²), retaining 82% of its initial capacity (170 mAh g⁻¹) at 0.1 C (FIG. 18C). The average working voltage of full cell was ˜3.8 V, providing high energy density of 700 Wh kg⁻¹. Such a specific capacity and cycling stability can be comparable to or better than some state-of-the-art NCM/Si full cells reported recently (Table 6), such as NCM811/porous Si (65 mAh g⁻¹, 300 cycles-45%), NCM811/Si-C composite (70 mAh g⁻¹, 100 cycles-44%), NCM811/Si@C-Ag composite (150 mAh g⁻¹, 20 cycles-55%), NCM622/Si-C composite (120 mAh g⁻¹, 500 cycles-80%), and NCM523/Si with elastic gel polymer (110 mAh g⁻¹, 400 cycles-68%).

TABLE 6

| | 1^{st} | Reversible | |
|---|---|---|---|
| | cycle | capacity | Cycling |
| Full cell | CE | (mAh g⁻¹) | number/retention |
| NCM811/prelithiated M—Si—4 | 87% | 140 | 200, 82% |
| NCM811/porous Si | 79% | 65 | 300, 45% |
| NCM811/prelithiated Si—C composite | 95% | 70 | 100, 44% |
| NCM811/Si@C—Ag composite | 40% | 150 | 20, 55% |
| NCM622/prelithiated Si—C composite | 80% | 120 | 500, 80% |
| NCM523/Si with elastic gel polymer | 84% | 110 | 400, 68% |
| NCM111/Si with self-healing binder | 76% | 118 | 120, 80% |
| NCM111/prelithiated ant-nest-like C@Si | 93% | 120 | 400, 82% |
| NCM111/prelithiated Si—C-graphite | 90% | 125 | 300, 84% |
| NCM111/CNT@Si@C | 82% | 125 | 500, 92% |

Table 5 lists electrochemical performances of some representative high-performance Si anodes reported recently for further comparison. Among these state-of-the-art electrodes, our montmorillonite-based Si exhibited the superior mass loading, initial CE and capacity retention. By further optimizing the structure and composition of electrode material (e.g., Si/SiO₂ ratio), as well as applying full anode prelithiation and carbon coating, we believe the full cell performance can be improved to a much higher level.

The resulting several nanometer-thick layered structure can provide abundant space for the volume expansion of Si and transportation of Li ions. Under reduction time of 4 h, the as-prepared material (M-Si-4) revealed an optimum Si/SiO₂ atomic ratio of ˜1.4 and the largest surface area of 137 m² g⁻¹. Such the anode material can present a high reversible capacity of ˜1130 mAh g⁻¹ (about 3-4 times of commercial graphite) after repeated cycling of 500 cycles at 0.2 C with outstanding capacity retention of 92%. The electrode even can maintain 83% of its initial capacity over 1000 cycles at 0.5 C. A pouch cell based on NCM811 cathode and the M-Si-4 anode demonstrated an initial specific capacity of 170 mAh g⁻¹ with high capacity retention of 82% after 200 cycles. These results suggest the great promise of applying montmorillonite-derived layered Si/SiO₂ network as high-performance anode for next-generation batteries.

### EXAMPLE 5: PREPARATION OF SILICON (MONTMORILLONITE PRECURSOR)

In a typical synthesis process, 1 g of montmorillonite powder (Sigma-Aldrich) and 0.8 g of granular Mg (Sigma-Aldrich) was mixed uniformly, before being placed in home-made titanium boat. The mixture was heated to a temperature of 650° C. in a tube furnace (Thermo Scientific, Lindberg Blue M) under argon atmosphere for different reaction time (2, 4, 6 or 8 h) to control the ratio of Si/SiO₂. After impregnation in 2 M HCl for 10 h, thoroughly washing using deionized water and vacuum drying at 60° C., brown color products were obtained. The montmorillonite-derived Si/SiO₂ samples were denoted according to their reduction time (M-Si—X). For example, the product prepared at reduction time of 4 h was denoted as M-Si-4.

In summary, the materials and methods disclosed herein provide a facile approach to synthesize microscale Si anode material from low-cost diatomite or montmorillonite. As will be apparent to those in the art, the disclosed methods may be applicable to other Si-containing precursors to create Si/SiO₂ networks that can be used as high-performance anodes for next-generation Lithium-ion batteries.

1. A composition for use as an anode material for a Li-ion battery, wherein the anode material is generated by magnesiothermic reduction of a SiO₂ constituent in a silicon-containing precursor, wherein the precursor is reduced to form a Si/SiO₂ composite network with crystalline Si domains embedded within an amorphous SiO₂ matrix.

2. The composition of claim 1, wherein the magnesiothermic reduction is carried out for a reduction time selected to control a ratio between the crystalline Si domains and the amorphous SiO₂ constituent.

3. The composition of claim 1, wherein the silicon-containing precursor is one of diatomite and monmorillonite.

4. (canceled)

5. The composition of claim 1, wherein the reduction time is within a range of 2 to 10 hours.

6. The composition of claim 1, wherein the magnesiothermic reduction is carried out in an inert atmosphere.

7. The composition of claim 1, wherein the crystalline Si domains have a size distribution in a range of 10-30 nm.

8. A composition for use as an anode for a lithium-ion battery, the composition comprising a Si-precursor-derived hierarchical porous Si/SiO₂ network formed by magnesiothermic reduction of a Si-precursor.

9. (canceled)

10. The composition of claim 8, wherein the Si-precursor is diatomite or monmorillonite.

11. (canceled)

12. The composition of claim 8, wherein the magnesiothermic reduction is carried out for a reduction time selected to control a ratio between crystalline Si domains and an amorphous SiO₂ constituent.

13. The composition of claim 12, wherein the reduction time is within a range of 2 to 10 hours.

14. The composition of claim 8, wherein the magnesiothermic reduction is carried out in an inert atmosphere.

15. The composition of claim 8, wherein the Si/SiO₂ network comprises crystalline Si domains having a size distribution in a range of 10-30 nm.

16. An anode for a Li-ion battery comprising a Si/SiO₂ composite network with crystalline Si domains embedded within an amorphous SiO₂ matrix, wherein the Si/SiO₂ composite network is generated by magnesiothermic reduction of a SiO₂ constituent in diatomite or montmorillonite.

17-18. (canceled)

19. The anode of claim 16, wherein the magnesiothermic reduction is carried out for a reduction time selected to control a ratio between the crystalline Si domains and the amorphous SiO₂ constituent.

20. The anode of claim 19, wherein the reduction time is within a range of 2 to 10 hours.

21. The anode of claim 19, wherein the magnesiothermic reduction is carried out in an inert atmosphere.

22. The anode of claim 16, wherein the crystalline Si domains have a size distribution in a range of 10-30 nm.

23. A method for fabricating an anode for a Li-ion battery comprising:
reducing a Si-containing precursor to form a Si/SiO₂ composite network with crystalline Si domains embedded within an amorphous SiO₂ matrix.

24. The method of claim 23, wherein the Si-containing precursor comprises diatomite or montmorillonite.

25. The method of claim 23, wherein reducing the Si-containing precursor comprises:
mixing the Si-containing precursor with magnesium to form a powder;
heating the powder in an inert atmosphere for a reduction time;
removing magnesium by-product by acid leaching; and
washing and drying the acid-leached material to form the Si/SiO₂ composite network.

26. The method of claim 25, wherein the reduction time is within a range of 2 to 10 hours.

27. The method of claim 23, wherein the crystalline Si domains have a size distribution in the range of 10-30 nm.
